(19) United States
(12) Patent Application Publication
(10) Pub. No.: US 2026/0059581 A1
(43) Pub. Date: Feb. 26, 2026

(54) Preamble Transmissions for a Random Access Procedure

(71) Applicant: Ofinno, LLC, Reston, VA (US)

(72) Inventors: Gautham Prasad, Herndon, VA (US); Ali Cagatay Cirik, Chantilly, VA (US); Esmael Hejazi Dinan, McLean, VA (US); Hyoungsuk Jeon, Centreville, VA (US); Hua Zhou, Vienna, VA (US); Mohammad Ghadir Khoshkholgh Dashtaki, Reston, VA (US)

(73) Assignee: Ofinno, LLC, Reston, VA (US)

(21) Appl. No.: 19/377,408

(22) Filed: Nov. 3, 2025

Related U.S. Application Data
(63) Continuation of application No. PCT/US2024/040792, filed on Aug. 2, 2024.
(60) Provisional application No. 63/530,411, filed on Aug. 2, 2023.

(51) Int. Cl. H04W 74/0833

(52) U.S. Cl. CPC H04W 74/0833

(57) ABSTRACT

A method can include receiving, by a wireless device, one or more configuration parameters indicating a synchronization signal block (SSB). The method can also include determining, based on a received signal power of the SSB, a number of repetitions of a preamble for a random access procedure. The method can further include determining a gap between a first symbol of a first repetition, of the number of repetitions, of the preamble in a first slot and a second symbol of a second repetition, of the number of repetitions, of the preamble in a second slot to be less than a first number of symbols. The method can additionally include foregoing, skipping, omitting, or otherwise not transmitting the second repetition of the preamble based on determining the gap to be less than the first number of symbols.

### CROSS-REFERENCE TO RELATED APPLICATIONS

This application is a continuation of International Application No. PCT/US2024/040792, filed Aug. 2, 2024, which claims the benefit of U.S. Provisional Application No. 63/530,411, filed Aug. 2, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 shows an example timing diagram of CE levels as per an aspect of an embodiment of the present disclosure.

FIG. 18A shows an example diagram of time and frequency resources as per an aspect of an embodiment of the present disclosure.

FIG. 18B shows an example association of a plurality of RO groups and a plurality of numbers of RA preamble/PRACH repetitions/transmissions.

FIG. 19 shows an example diagram of time and frequency resources as per an aspect of an embodiment of the present disclosure.

FIG. 20 shows an example diagram of time and frequency resources as per an aspect of an embodiment of the present disclosure.

FIG. 21 illustrates an example timing diagram as per an aspect of an embodiment of the present disclosure.

FIG. 22 illustrates an example of one or more uplink transmissions as per an aspect of an embodiment of the present disclosure.

FIG. 23A illustrates an example timing diagram as per an aspect of an embodiment of the present disclosure.

FIG. 23B illustrates an example timing diagram as per an aspect of an embodiment of the present disclosure.

FIG. 24 illustrates an example flow diagram as per an aspect of an embodiment of the present disclosure.

FIG. 25 illustrates an example flow diagram as per an aspect of an embodiment of the present disclosure.

FIG. 26 shows procedure(s) for LTM as per an aspect of an embodiment of the present disclosure.

FIG. 27 illustrates an example timing diagram as per an aspect of an embodiment of the present disclosure.

FIG. 28 illustrates an example timing diagram as per an aspect of an embodiment of the present disclosure.

FIG. 29 illustrates an example flowchart as per an aspect of an embodiment of the present disclosure.

FIG. 30 illustrates an example flowchart as per an aspect of an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

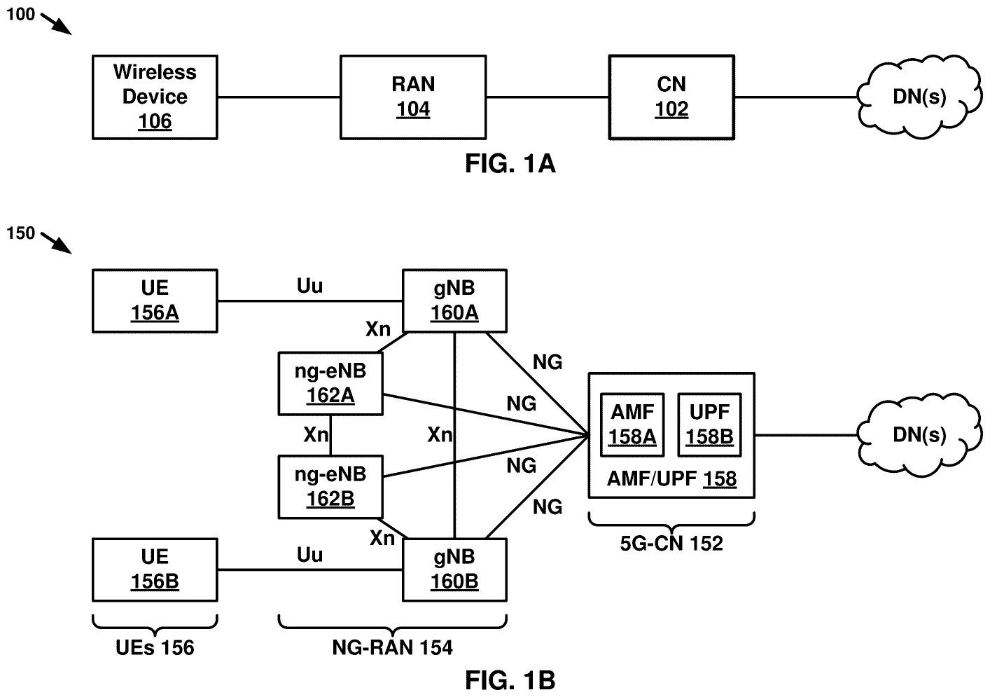

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNs (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNs (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

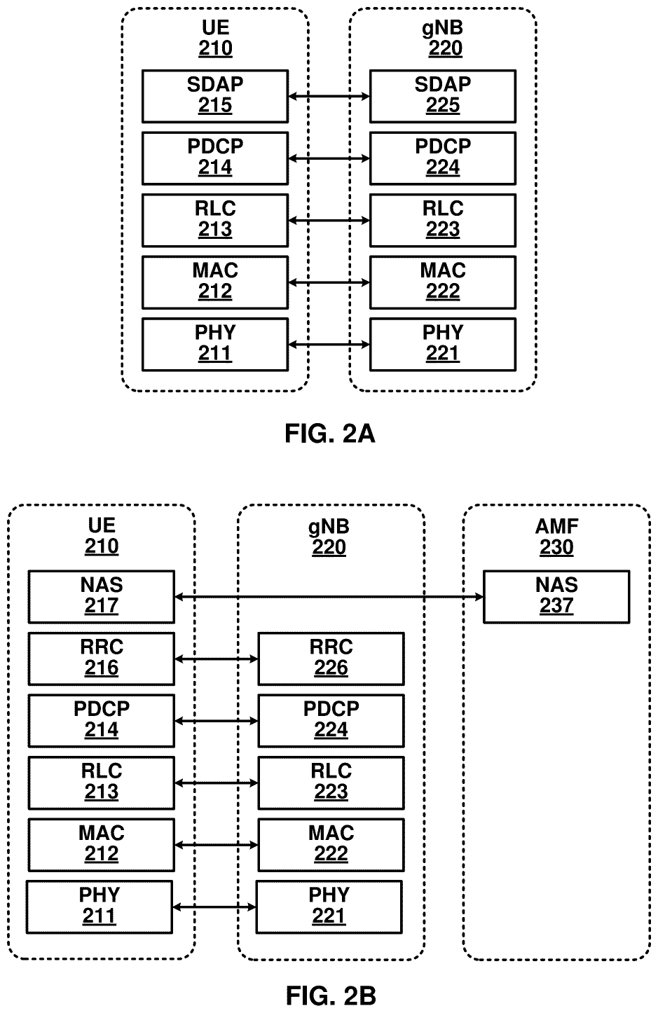

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

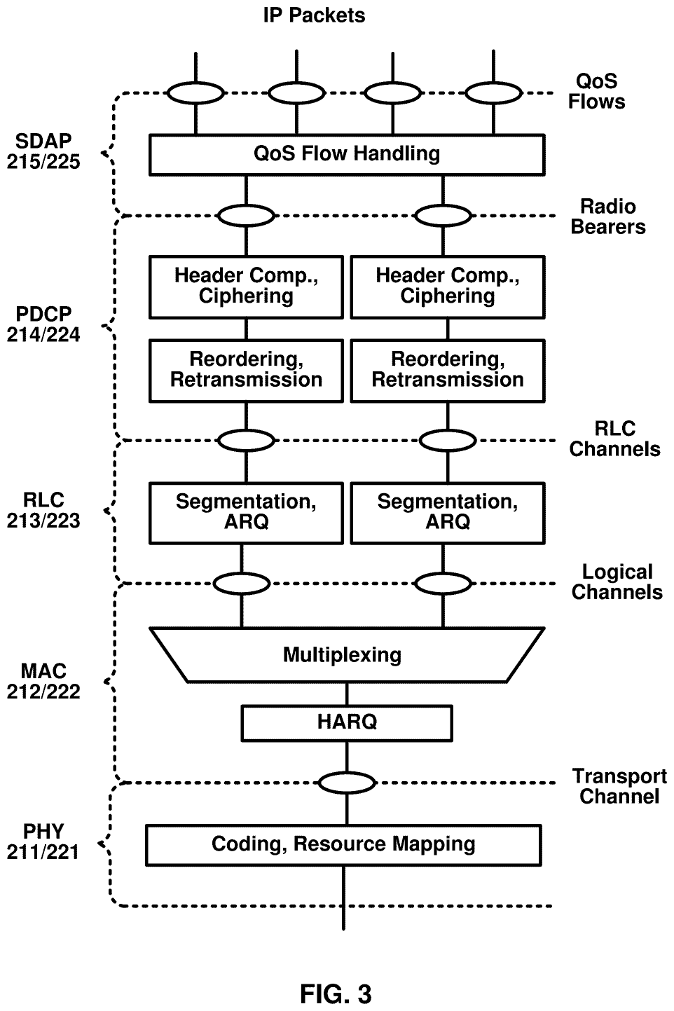

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

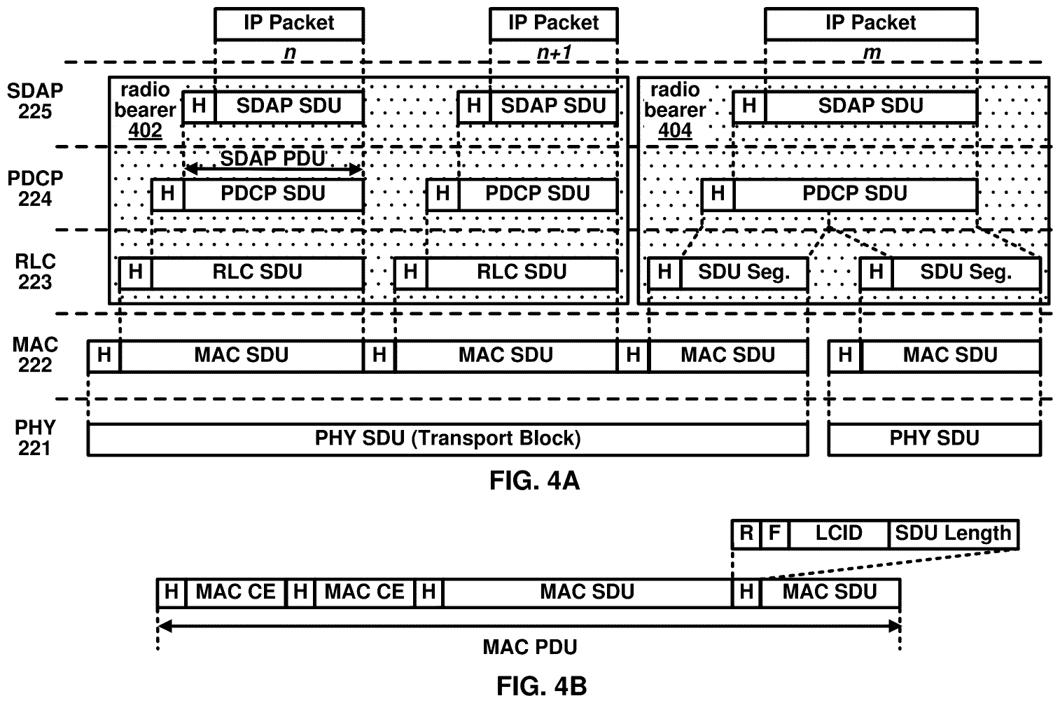

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 212 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

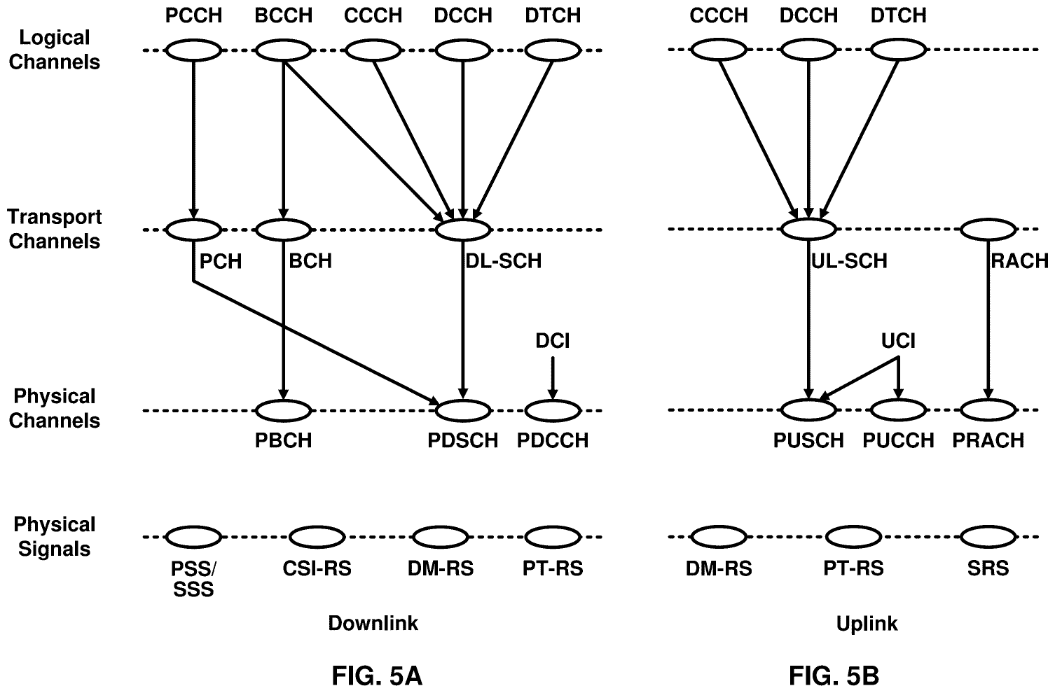

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the N R control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR includes, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR includes, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR includes, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

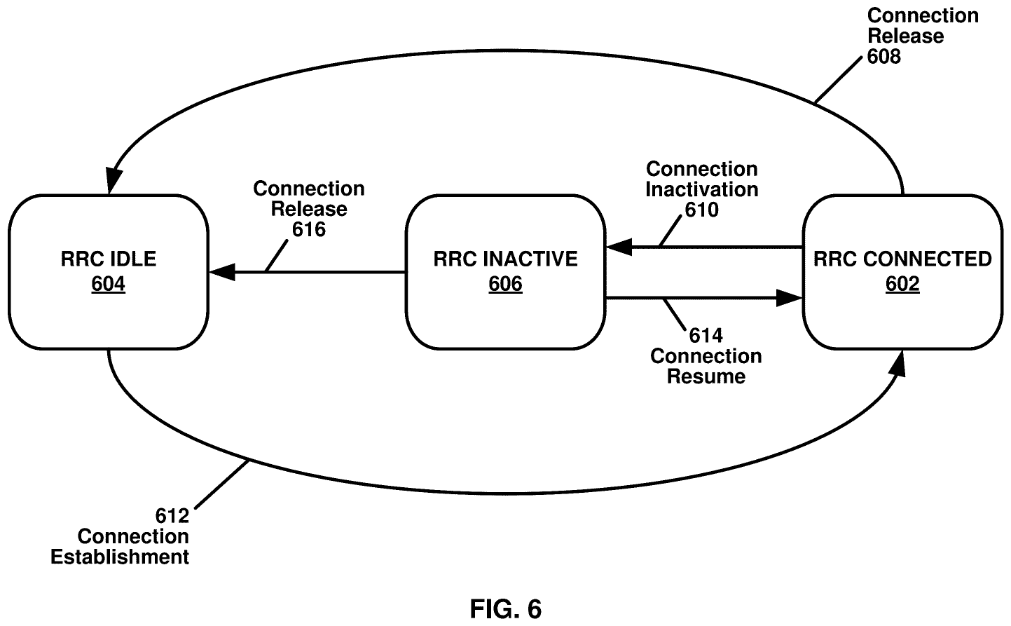

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split into two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

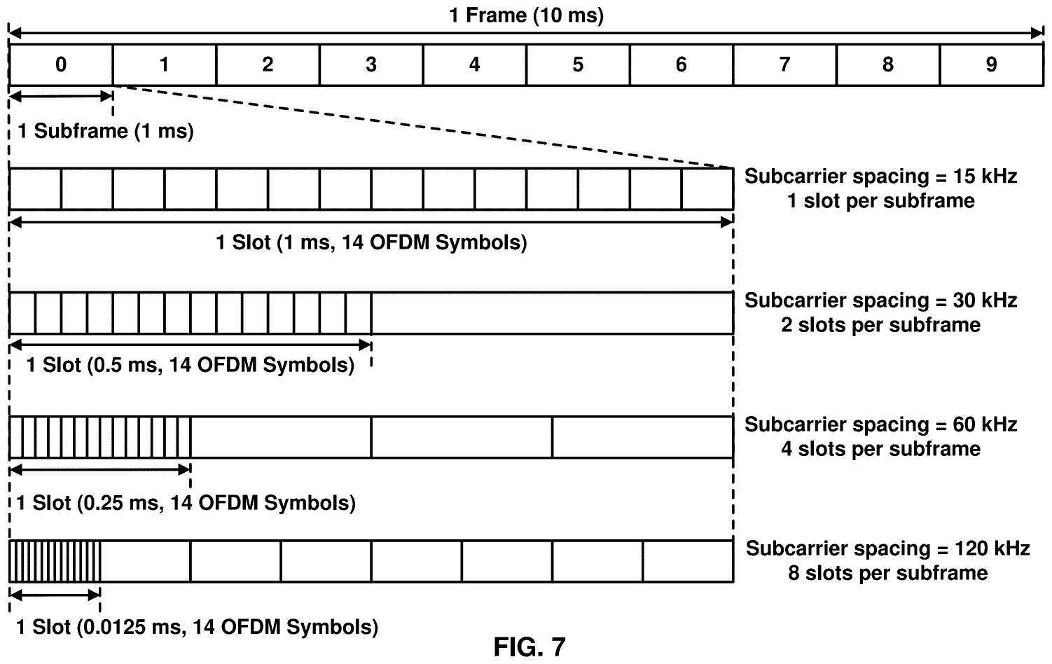

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 kHz/2.3 μs; 60 kHz/1.2 μs; 120 kHz/0.59 μs; and 240 kHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

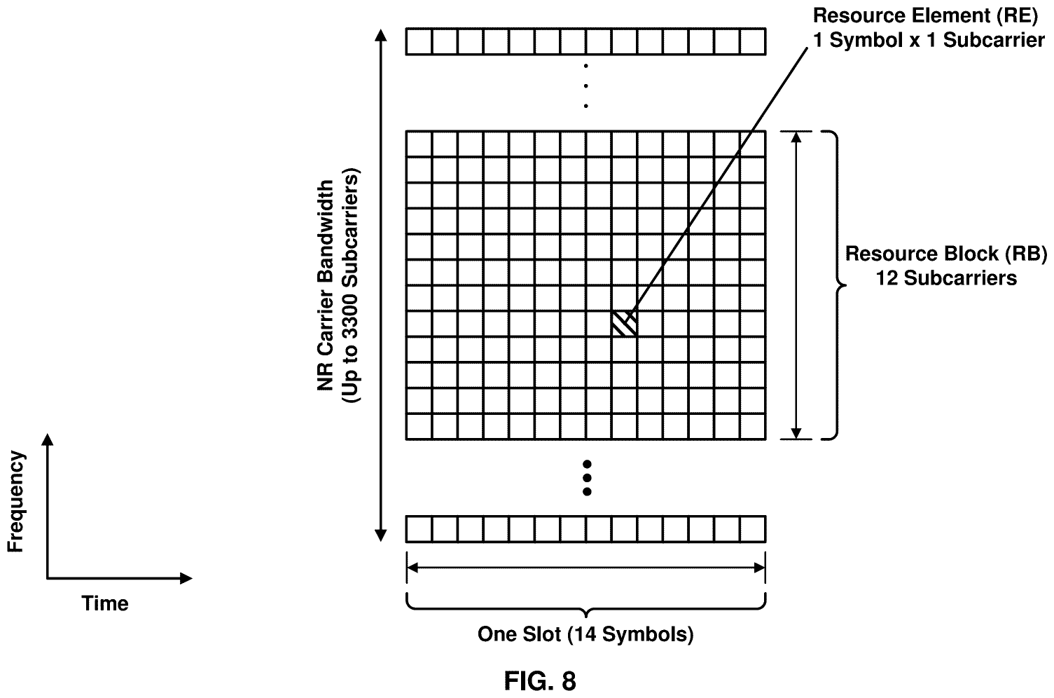

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

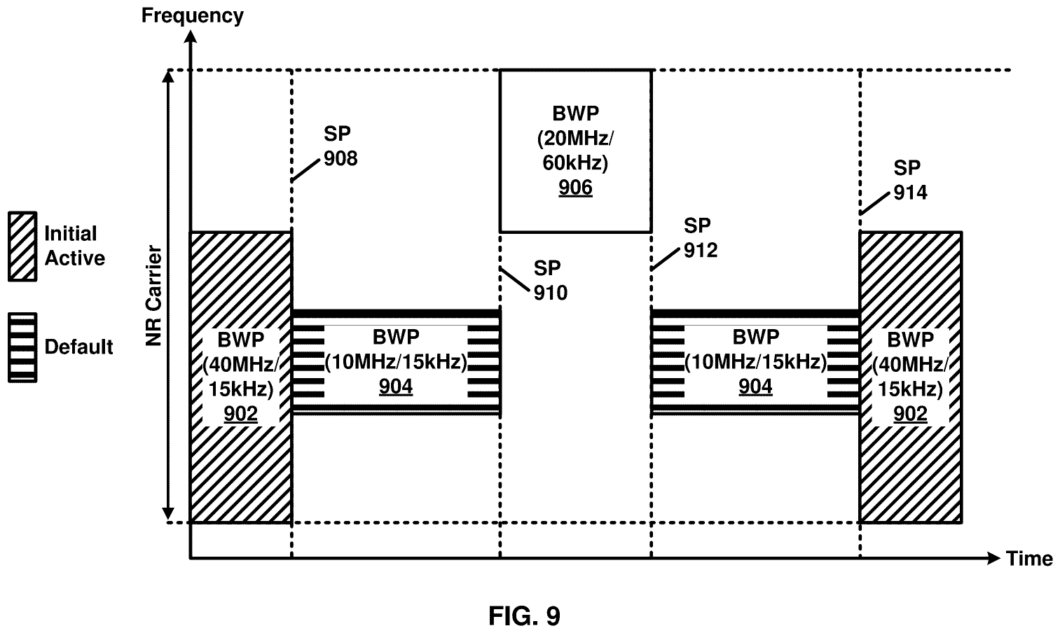

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

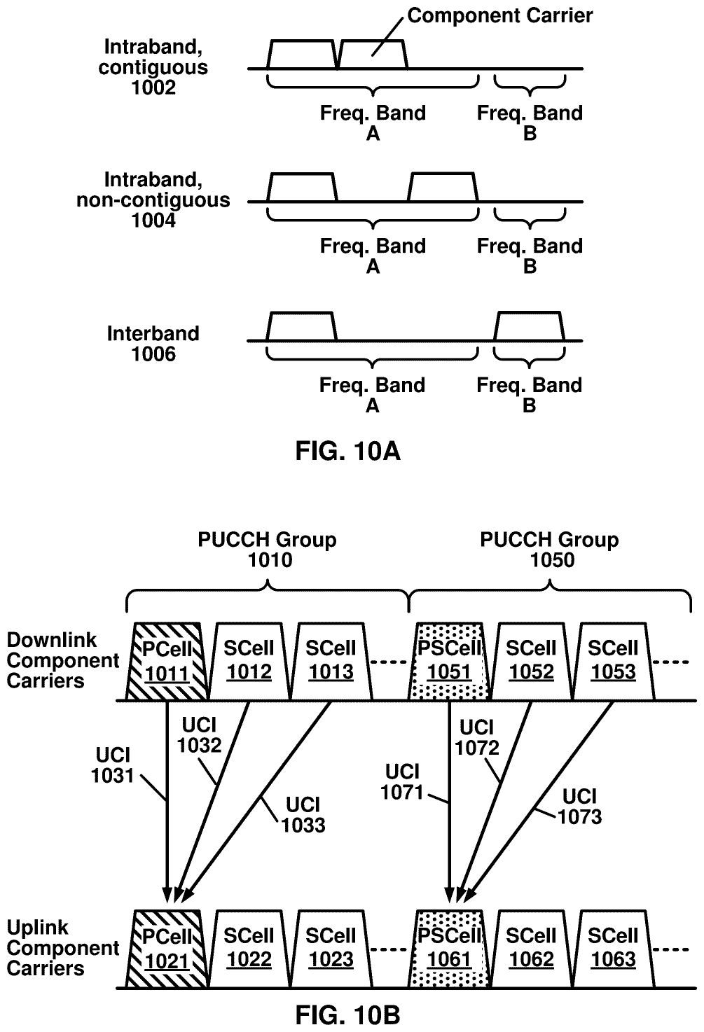

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

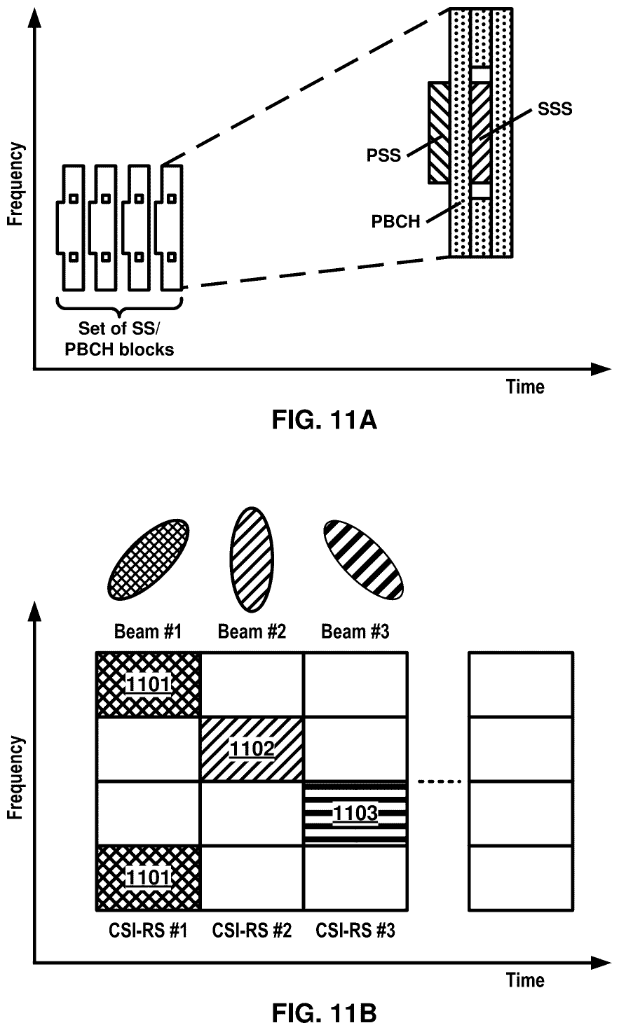

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

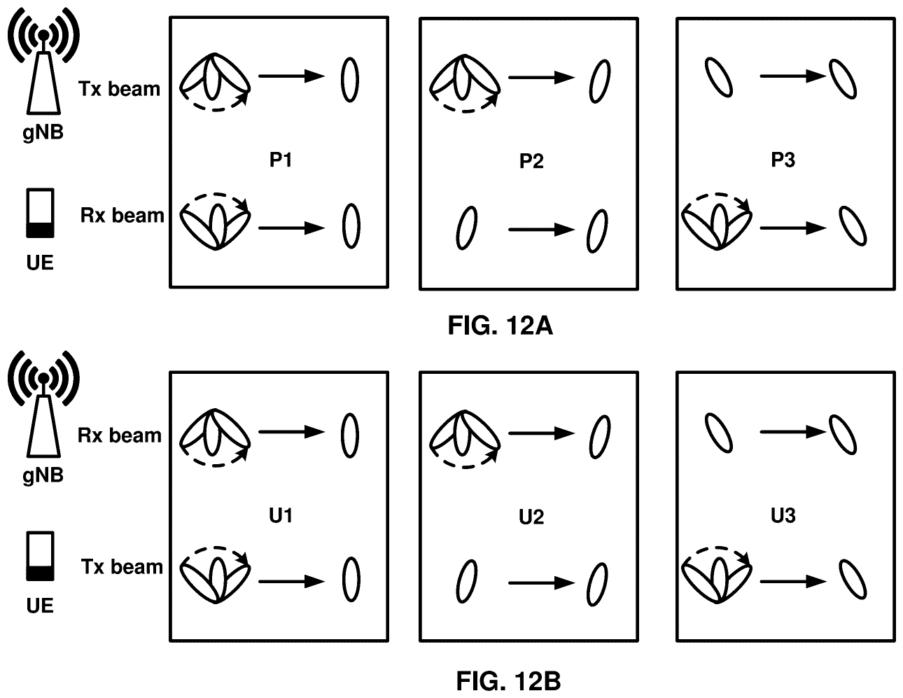

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

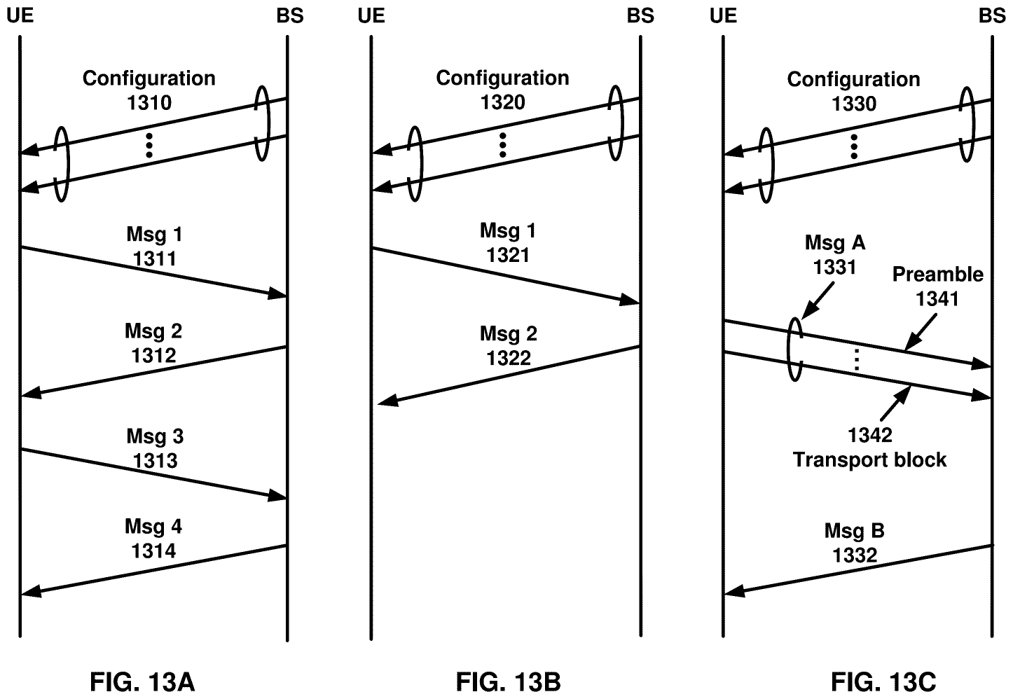

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGenera); cell-specific parameters (e.g., RA CH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-Response Window) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg2 1322. The Msg 1 1321 and the Msg2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-Response Window) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 00 may be used for scheduling of PUSCH in a cell. DCI format 00 may be a fallback DCI format (e.g., with compact DCI payloads). DCI format 01 may be used for scheduling of PUSCH in a cell (e.g., with more DCI payloads than DCI format 0_0). DCI format 10 may be used for scheduling of PDSCH in a cell. DCI format 10 may be a fallback DCI format (e.g., with compact DCI payloads). DCI format 11 may be used for scheduling of PDSCH in a cell (e.g., with more DCI payloads than DCI format 1_0). DCI format 20 may be used for providing a slot format indication to a group of UEs. DCI format 21 may be used for notifying a group of UEs of a physical resource block and/or OFDM symbol where the UE may assume no transmission is intended to the UE. DCI format 22 may be used for transmission of a transmit power control (TPC) command for PUCCH or PUSCH. DCI format 23 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

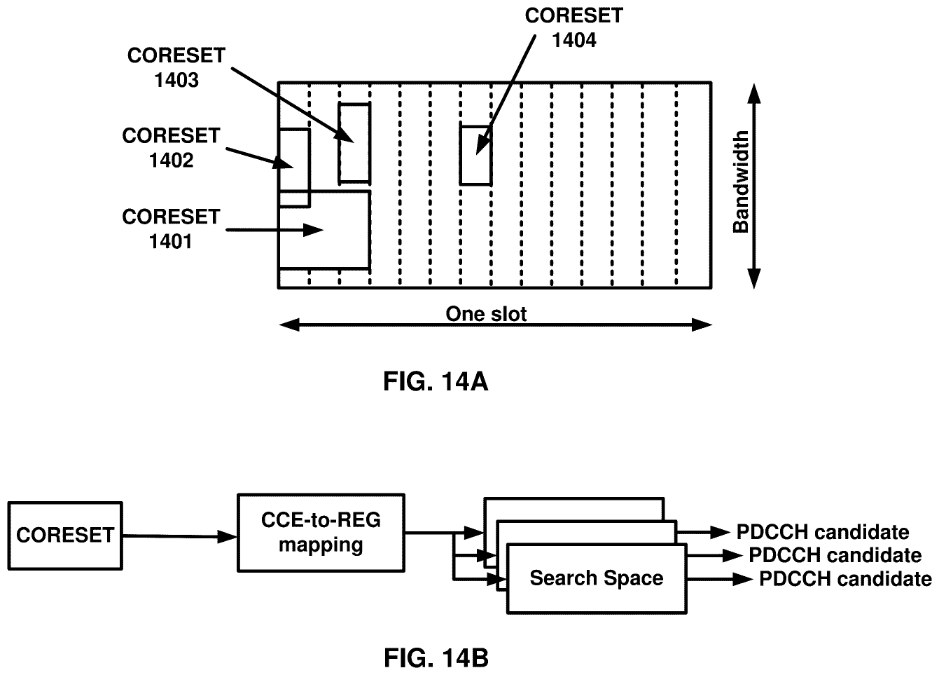

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 10 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

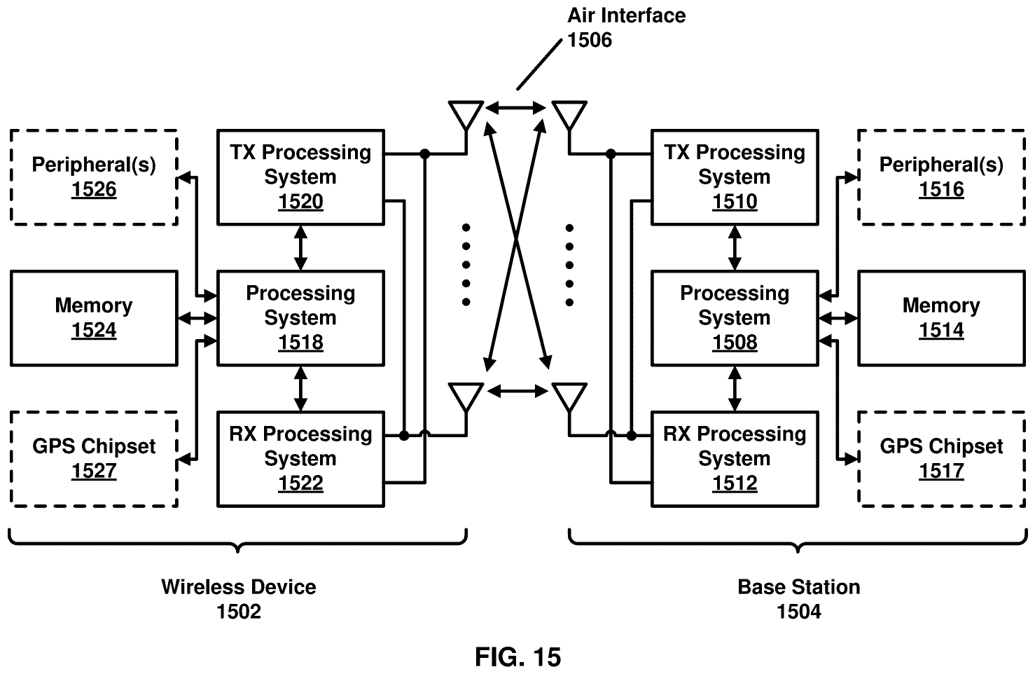

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

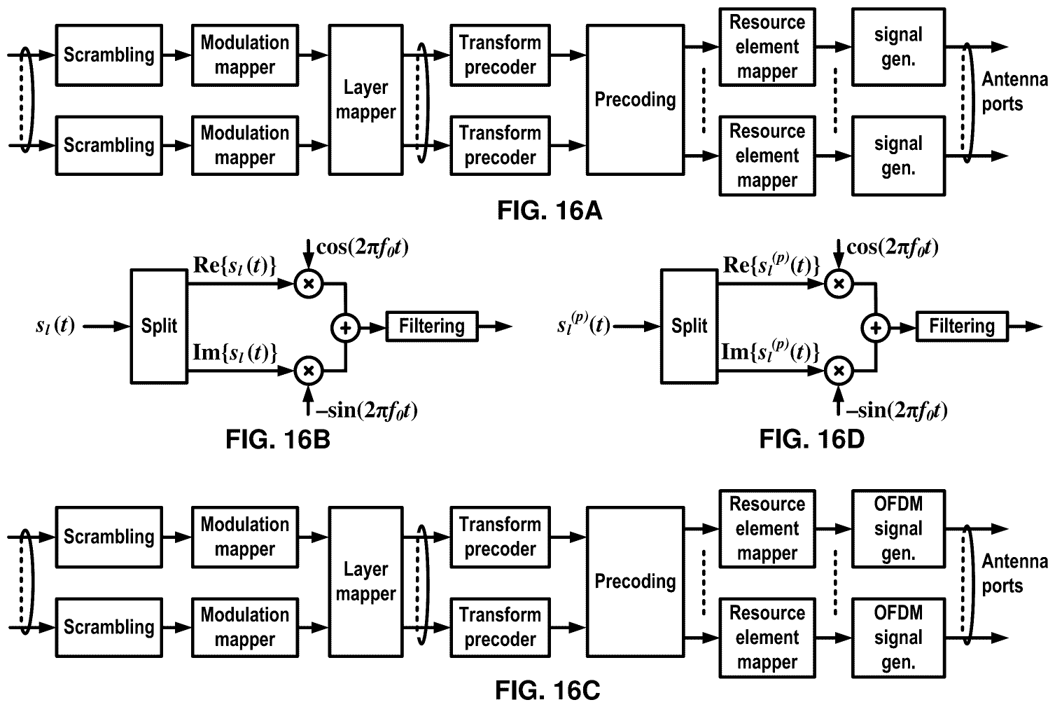

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual connectivity) via the plurality of cells. The one or more messages (e.g. as a part of the configuration parameters) may comprise parameters of physical, MAC, RLC, PCDP, SDAP, and RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

To improve coverage (e.g., in FR1 and/or FR2), following enhancements on physical uplink (UL) shared channel (PUSCH), physical UL control channel (PUCCH), and/or MSG3 on PUSCH may be supported/implemented:
Enhanced aggregation of multiple slots with transport block (TB) repetition may be supported/implemented for both PUSCH transmission with dynamic and configured grant. Counting based on available slots may be supported. The maximum number of aggregated slots for counting based on available slots and counting based on physical slots may be both 32.
TB processing over multiple slots with and without repetition may be supported/implemented for both PUSCH transmission with dynamic grant and configured grant. For a single transmission of TB processing over multiple slots PUSCH, the TB size may be determined based on multiple slots.
demodulation reference signal (DMRS) bundling where a wireless device maintains phase continuity and power consistency across PUSCH transmissions or PUCCH repetitions to enable improved channel estimation may be supported/implemented. Inter-slot frequency hopping with DMRS bundling may be supported/implemented.
Dynamic PUCCH repetition factor indication may be configured (e.g., by the base station) per PUCCH resource, which may be applicable to all PUCCH formats.
Aggregation of multiple slots with TB repetition for MSG3 transmission may be supported/implemented on both normal UL (NUL) and supplementary UL (SUL), applicable to contention based random access (CBRA) with 4-step RA type. If configured, the wireless device may request MSG3 repetition via separate random access channel (RACH) resources when the reference signal received power (RSRP) of DL path-loss reference is lower than a configured threshold. Bandwidth part (BWP) configured with RACH resources solely for MSG3 repetition may be supported/implemented/configured without the need to consider the RSRP of DL path-loss reference by the wireless device.

Coverage may be one of the key factors that an operator considers when commercializing cellular communication networks due to its direct impact on service quality as well as capital expenditure and operation expenditure. UL performance may be a bottleneck in most scenarios in real deployment, while there are emerging vertical use cases that have UL heavy traffic, e.g., video uploading.

Coverage enhancement (CE) may be achieved, for example, with repetitions (e.g., multiple transmissions). For example, CE for a random access (RA) preamble (e.g., physical random access channel (PRACH) transmission) may be achieved with/by RA preamble/PRACH repetitions (e.g., multiple PRACH transmissions).

Multiple/plurality of RA preamble/PRACH repetitions/transmissions may be performed/transmitted using a same beam. For example, the multiple/plurality of PRACH/RA preamble transmissions/repetitions may comprise a first PRACH/RA preamble transmission/repetition. The multiple/plurality of PRACH/RA preamble transmissions/repetitions may comprise a second PRACH/RA preamble transmission/repetition. In an example, the wireless device may transmit/perform the first PRACH/RA preamble transmission/repetition using/with/via a first beam/spatial (domain transmission) filter. In an example, the wireless device may transmit/perform the first PRACH/RA preamble transmission/repetition using/with/via a second beam/spatial (domain transmission) filter. The first beam/spatial (domain transmission) filter and the second beam/spatial (domain transmission) filter may be, for example, the same (e.g., identical, not different).

The first beam/spatial (domain transmission) filter and the second beam/spatial (domain transmission) filter may, for example, be different (e.g., not the same, not identical).

In an example, the wireless device may transmit/perform the first PRACH/RA preamble transmission/repetition using/with/via one or more first RA resources. The wireless device may transmit/perform the second PRACH/RA preamble transmission/repetition using/with/via one or more second RA resources. The first RA resources and the second RA resources may, for example, be associated with a same reference signal (e.g., synchronization signal block or synchronization signal/physical broadcast channel (PBCH) block (SSB), channel state information-reference signal (CSI-RS), and the like). The one or more first RA resources and the one or more second RA resources may, for example, be associated with different reference signals (RSs).

RA resource(s) (e.g., the one or more first RA resources, the one or more second RA resources, and the like) may comprise one or more RA preambles. RA resource(s) (e.g., the one or more first RA resources, the one or more second RA resources, and the like) may comprise one or more root sequences for the one or more RA preambles. RA resource(s) (e.g., the one or more first RA resources, the one or more second RA resources, and the like) may comprise one or more RA prioritizations. RA resource(s) (e.g., the one or more first RA resources, the one or more second RA resources, and the like) may comprise one or more feature combination for an RA procedure. RA resource(s) (e.g., the one or more first RA resources, the one or more second RA resources, and the like) may comprise one or more reference signals for the RA procedure. RA resource(s) (e.g., the one or more first RA resources, the one or more second RA resources, and the like) may comprise one or more target received power values. RA resource(s) (e.g., the one or more first RA resources, the one or more second RA resources, and the like) may comprise one or more starting frequencies. RA resource(s) (e.g., the one or more first RA resources, the one or more second RA resources, and the like) may comprise one or more PRACH configuration indexes.

In an example, the wireless device may transmit/perform the first PRACH/RA preamble transmission/repetition using/with a first transmit/transmission power. The wireless device may transmit/perform the second PRACH/RA preamble transmission/repetition using/with a second transmit/transmission power. The first transmit/transmission power may be, for example, the same as the second transmit/transmission power. The first transmit/transmission power may, for example, be different (e.g., greater, less, weaker, stronger, and the like) than/from the second transmit/transmission power.

In an example, the multiple/plurality of PRACH/RA preamble transmissions/repetitions may be within/for/in/via a single/same RA/RACH attempt (e.g., the multiple/plurality of PRACH/RA preamble transmissions/repetitions may be transmitted/performed when a counter (e.g., preamble transmission counter) is set/at a same value). The multiple/plurality of PRACH/RA preamble transmissions/repetitions may be, for example, for a same/single RA procedure.

The multiple/plurality of PRACH/RA preamble transmissions/repetitions may comprise a first number of PRACH/RA preamble transmissions/repetitions. The wireless device may determine the first number of PRACH/RA preamble transmissions/repetitions, for example, based on a radio link quality of a reference signal (RS). For example, the wireless device may determine (e.g., select, choose, and the like) a first RS (e.g., SSB, CSI-RS) for an RA procedure. The wireless device may determine the first number of PRACH/RA preamble transmissions/repetitions for the RA procedure, for example, based on a radio link quality of the first RS (e.g., SSB, CSI-RS).

The wireless device may receive one or more messages (e.g., one or more RRC messages, one or more system information messages, and the like) from a base station. The one or more messages may comprise one or more configuration parameters. The one or more configuration parameters may comprise, for example, one or more RA channel (RACH) configuration parameters. The one or more configuration parameters may indicate/comprise one or more power thresholds. The one or more power thresholds may be for determining a number of PRACH/RA preamble transmissions/repetitions. For example, the wireless device may compare the radio link quality of the first RS (e.g., SSB) with/against the one or more power thresholds to determine the number of PRACH/RA preamble transmissions/repetitions.

For example, the one or more power thresholds may comprise a first power threshold, a second power threshold, and a third power threshold. The wireless device may determine the number of PRACH/RA preamble transmissions/repetitions based on the one or more power thresholds and the radio link quality of the first RS (e.g., SSB), for example, as follows:
if the radio link quality of the first RS (e.g., SSB) is less than the first power threshold and the wireless device is capable of (or supports) a first number of PRACH/RA preamble transmissions/repetitions, the wireless device (or a MAC entity of the wireless device) may determine a number of PRACH/RA preamble transmissions/repetitions to be the first number of PRACH/RA preamble transmissions/repetitions.
else if the radio link quality of the first RS (e.g., SSB) is less than the second power threshold and the wireless device is capable of (or supports) a second number of PRACH/RA preamble transmissions/repetitions, the wireless device (or a MAC entity of the wireless device) may determine the number of PRACH/RA preamble transmissions/repetitions to be the second number of PRACH/RA preamble transmissions/repetitions.
else if the radio link quality of the first RS (e.g., SSB) is less than the third power threshold and the wireless device is capable of (or supports) a third number of PRACH/RA preamble transmissions/repetitions, the wireless device (or a MAC entity of the wireless device) may determine the number of PRACH/RA preamble transmissions/repetitions to be the third number of PRACH/RA preamble transmissions/repetitions.
else the wireless device (or a MAC entity of the wireless device) may determine the number of PRACH/RA preamble transmissions/repetitions to be a fourth number of PRACH/RA preamble transmissions/repetitions.

In some embodiments, numbers of RA preamble/PRACH repetitions/transmissions and coverage enhancement (CE) levels may be analogous to each other (e.g., they may be used interchangeably). For example, a base station may indicate, via the one or more configuration parameters, a plurality of CE levels. The plurality of CE levels may be associated with/correspond to a plurality of numbers of RA preamble/PRACH repetitions/transmissions. For example, each CE level, of the plurality of CE levels, may associated with/correspond to a respective number of RA preamble/PRACH repetitions/transmissions, of the plurality of numbers of RA preamble/PRACH repetitions/transmissions.

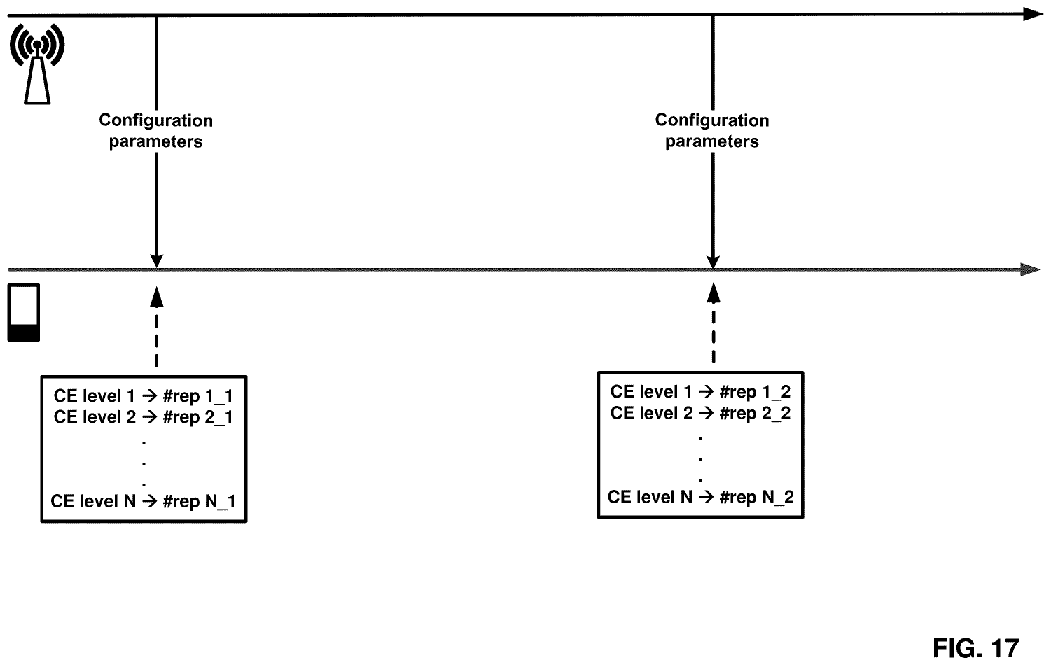

FIG. 17 shows an example timing diagram of CE levels as per an aspect of an embodiment of the present disclosure. In the example of FIG. 17, the wireless device may receive one or more configuration parameters. The one or more configuration parameters may be for a cell. The wireless device may receive the one or more configuration parameters via the cell. The wireless device may receive the one or more configuration parameters from a base station. The base station may serve the cell.

The one or more configuration parameters may indicate a plurality of CE levels. The plurality of CE levels may be for/associated with/correspond to a plurality of features/feature combinations. Each CE level, of the plurality of CE levels, may be for/associated with/correspond to a respective feature/feature combination of the plurality of features/feature combinations.

In some embodiments, CE level(s) and feature(s)/feature combination(s) may be used interchangeably (e.g., may mean/refer to the same).

In some embodiments, a plurality of RA preamble/PRACH repetitions/transmissions (e.g., number of RA preamble/PRACH repetitions/transmissions where the number is greater than one) may be/comprise/refer to a feature/feature combination. In some embodiments, CE level(s) may be/comprise/refer to a feature/feature combination.

Each CE level, of the plurality of CE levels, may be associated with/correspond to a respective number of RA preamble/PRACH repetitions/transmissions of a plurality of numbers of RA preamble/PRACH repetitions/transmissions. For example, the plurality of CE levels may comprise a first CE level (e.g., CE level 1 in FIG. 17). The first CE level may be associated with/correspond to a first number of RA preamble/PRACH repetitions/transmissions (e.g., #ep 1_1 in FIG. 17). The wireless device may receive one or more second configuration parameters (e.g., after receiving the one or more configuration parameters). The one or more second configuration parameters may re-assign/associate the plurality of CE levels to a second plurality of numbers of RA preamble/PRACH repetitions/transmissions. For example, the one or more second configuration parameters may indicate a second number of RA preamble/PRACH repetitions/transmissions (e.g., #ep 1_2 in FIG. 17) to be associated with/correspond to the first CE level (e.g., CE level 1 in FIG. 17). In an example, the first number of RA preamble/PRACH repetitions/transmissions may be the same as the second number of RA preamble/PRACH repetitions/transmissions. In an example, the first number of RA preamble/PRACH repetitions/transmissions may be different from the second number of RA preamble/PRACH repetitions/transmissions. For example, the first number of RA preamble/PRACH repetitions/transmissions may be four. The second number of RA preamble/PRACH repetitions/transmissions may be eight.

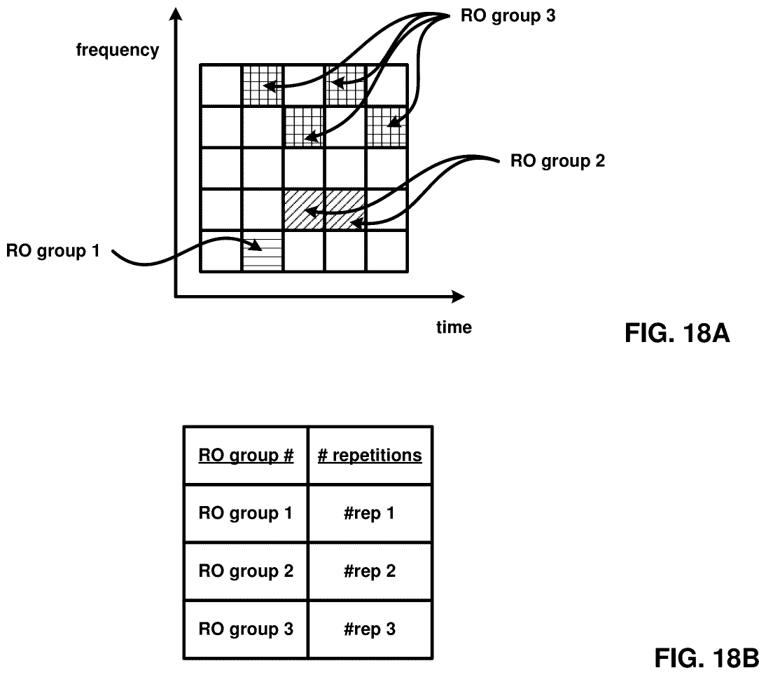

FIG. 18A shows an example diagram of time and frequency resources as per an aspect of an embodiment of the present disclosure. In the example of FIG. 18A, the time and frequency resources (e.g., RA/RACH/PRACH resources) may be divided/grouped into a plurality of RA RACH/PRACH occasion (RO) groups. Each RO group, of the plurality of RO groups, may comprise one or more ROs. Each RO, of the one or more ROs, may be associated with/for/correspond to a respective number of RA preamble/PRACH repetitions/transmissions of a plurality of numbers of RA preamble/PRACH repetitions/transmissions. The one or more configuration parameters may indicate the association/correspondence between the plurality of RO groups and the plurality of numbers of RA preamble/PRACH repetitions/transmissions.

FIG. 18B shows an example association of a plurality of RO groups and a plurality of numbers of RA preamble/PRACH repetitions/transmissions. In an example, the one or more configuration parameters may indicate the association, e.g., as shown in FIG. 18B. In an example, the one or more configuration parameters may indicate/comprise the table shown in FIG. 18B (e.g., the contents of the table in/as an ordered list). In an example, the one or more configuration parameters may indicate/comprise indexes to the table. In an example, the one or more configuration parameters may indicate the table as one or more lists/sets/arrays/rows/columns. In the example of FIG. 18B, the RO group 1 may be associated with a first number of RA preamble/PRACH repetitions/transmissions (e.g., 1, #ep 1). The RO group 2 may be associated with a second number of RA preamble/PRACH repetitions/transmissions (e.g., 2, #ep 2). The RO group 3 may be associated with a third number of RA preamble/PRACH repetitions/transmissions (e.g., 4, #ep 3). RO group 1, RO group 2, and/or RO group 3 from/in FIG. 18B may be the same as RO group 1, RO group 2, and/or RO group 3 in/from FIG. 18A, respectively.

In the example of FIG. 18A, the plurality of RO groups may comprise a first RO group (e.g., RO group 1 in FIG. 18A). The first RO group may be associated with/for/correspond to a first number of RA preamble/PRACH repetitions/transmissions. The first RO group may comprise the first number of (valid) ROs. In the example of FIG. 18A, the first number may be one. In an example, the wireless device may determine a number of RA preamble/PRACH repetitions/transmissions to be the first number. The wireless device may transmit/perform the first number of RA preamble/PRACH repetitions/transmissions over/via/on/using one or more (valid) ROs from the first RO group, for example, based on the first RO group being associated with/for/corresponding to the first number (e.g., based on the one or more configuration parameters indicating the first RO group to be associated with/correspond to the first number of RA preamble/PRACH repetitions/transmissions, e.g., as shown in FIG. 18B). The one or more (valid) ROs from the first RO group may be associated with/correspond to/derived from a first reference signal (e.g., CSI-RS, SSB).

In the example of FIG. 18A, the plurality of RO groups may comprise a second RO group. The second RO group may be associated with/for/correspond to a second number of RA preamble/PRACH repetitions/transmissions (e.g., two in the example of FIG. 18A, #ep 2 in the example of FIG. 18B), e.g., based on the table/indication as shown in FIG. 18B. In an example, the wireless device may determine a number of RA preamble/PRACH repetitions/transmissions to be the second number (e.g., two). The wireless device may transmit/perform the second number of RA preamble/PRACH repetitions/transmissions over/via/on/using one or more (valid) ROs from the second RO group, for example, based on the second RO group being associated with/for/corresponding to the second number. The one or more (valid) ROs from the second RO group may be associated with/correspond to/derived from a second reference signal (e.g., CSI-RS, SSB). The first reference signal may be, for example, the same as the second reference signal.

The plurality of RO groups may comprise a third RO group. The third RO group may be associated with/for/correspond to a third number of RA preamble/PRACH repetitions/transmissions (e.g., four in the example of FIG. 18A, #ep 3 in the example of FIG. 18B). In an example, the wireless device may determine a number of RA preamble/PRACH repetitions/transmissions to be the third number. The wireless device may transmit/perform the third number of RA preamble/PRACH repetitions/transmissions over/via/on/using one or more (valid) ROs from the third RO group, for example, based on the third RO group being associated with/for/corresponding to the third number. The one or more (valid) ROs from the third RO group may be associated with/correspond to/derived from a third reference signal (e.g., CSI-RS, SSB). The third reference signal may be, for example, the same as the second reference signal.

In the example of FIG. 18A, no RO within/comprised in an RO group, of the plurality of RO groups, may be located at a same time instance (e.g., may fully/partially overlap in time).

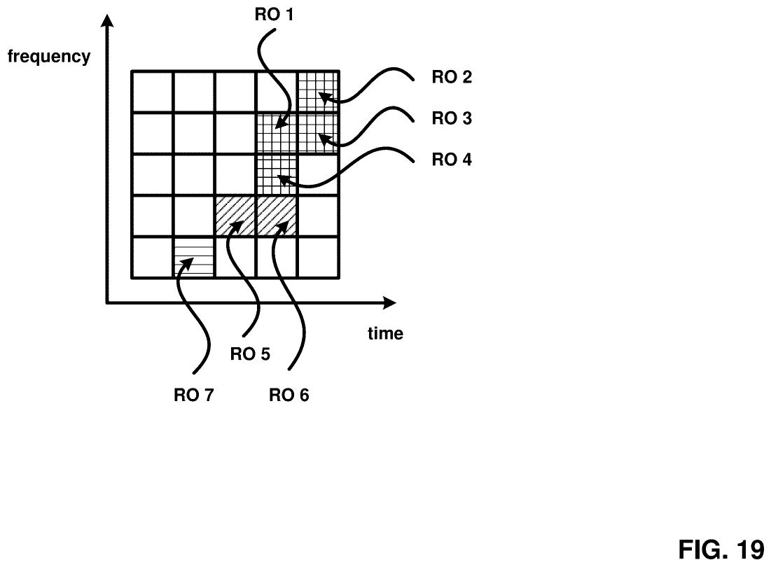

FIG. 19 shows an example diagram of time and frequency resources as per an aspect of an embodiment of the present disclosure. In the example of FIG. 19, the time and frequency resources (e.g., RA/RACH/PRACH resources) may be divided/grouped into a plurality of RO groups. Each RO group, of the plurality of RO groups, may comprise one or more ROs.

In the example of FIG. 19, the plurality of RO groups may comprise a first RO group. The first RO group may comprise a single (valid) RO (e.g., RO 7 in FIG. 19). The first RO group may be associated with/for/correspond to a first number of RA preamble/PRACH repetitions/transmissions (e.g., 1). Based on the first RO group being associated with/for/correspond to the first number of RA preamble/PRACH repetitions/transmissions (e.g., 1), the first RO group may comprise the first number of (valid) ROs (e.g., a single RO, e.g., RO 7 in FIG. 19).

The plurality of RO groups may comprise a second RO group. The second RO group may be associated with/for/correspond to a second number of RA preamble/PRACH repetitions/transmissions (e.g., 2). Based on the second RO group being associated with/for/correspond to the second number of RA preamble/PRACH repetitions/transmissions (e.g., 2), the second RO group may comprise the second number of (valid) ROs (e.g., two (valid) ROs). In the example of FIG. 19, the second RO group may comprise two (valid) ROs (e.g., RO 5 and RO 6).

The plurality of RO groups may comprise a third RO group. The third RO group may be associated with/for/correspond to a third number of RA preamble/PRACH repetitions/transmissions (e.g., 4). Based on the third RO group being associated with/for/correspond to the third number of RA preamble/PRACH repetitions/transmissions (e.g., 4), the third RO group may comprise the third number of (valid) ROs (e.g., four ROs). In the example of FIG. 19, the third RO group may comprise four (valid) ROs (e.g., RO 1, RO 2, RO 3, and RO 4).

The one or more configuration parameters may indicate an association between the plurality of RO groups and different/plurality/multiple numbers of RA preamble/PRACH repetitions/transmissions, for example, as in the example embodiment of FIG. 18B. For example, in the embodiment of FIG. 19, #ep 1 (from the example of FIG. 18B) may be one. For example, in the embodiment of FIG. 19, #ep 2 (from the example of FIG. 18B) may be two. For example, in the embodiment of FIG. 19, #ep 3 (from the example of FIG. 18B) may be four.

In the example of FIG. 19, a plurality of ROs may be located/situated/occur at a same time duration (e.g., time interval, time slot, slot, sub-frame, symbol, radio frame, and the like). For example, RO 2 and RO 3 in FIG. 19 are both located/situated/occur at a first time. RO 1 and RO 4 are both located/situated/occur at a second time. RO 2 and RO 3 may, for example, overlap with each other in time (e.g., entirely/fully overlap). RO 1 and RO 4 may, for example, overlap with each other in time (e.g., entirely/fully overlap).

Each RO group, of the plurality of RO groups, may comprise one or more valid ROs. A number of valid ROs comprised in an RO group may be equal to (e.g., substantially equal to) a number of RA preamble/PRACH repetitions/transmissions associated with/for/corresponding to the RO group.

In the example of FIG. 19, the first RO group may be associated with/for/correspond to a first number of RA preamble/PRACH repetitions/transmissions (e.g., 1). The first RO group may comprise a single valid RO, for example, based on the first RO group being associated with/for/corresponding to the first number of RA preamble/PRACH repetitions/transmissions (e.g., 1). The single valid RO in/of the first RO group in FIG. 19 is RO 7.

In the example of FIG. 19, the second RO group may be associated with/for/correspond to the second number of RA preamble/PRACH repetitions/transmissions (e.g., 2). The second RO group may comprise two valid ROs, for example, based on the second RO group being associated with/for/corresponding to the second number of RA preamble/PRACH repetitions/transmissions (e.g., 2). The two valid ROs in/of the second RO group in FIG. 19 are RO 5 and RO 6.

In the example of FIG. 19, the third RO group may be associated with/for/correspond to the third number of RA preamble/PRACH repetitions/transmissions (e.g., 4). The third RO group may comprise four valid ROs, for example, based on the third RO group being associated with/for/corresponding to the third number of RA preamble/PRACH repetitions/transmissions (e.g., 4). The four valid ROs in/of the third RO group in FIG. 19 are RO 1, RO 2, RO 3, and RO 4.

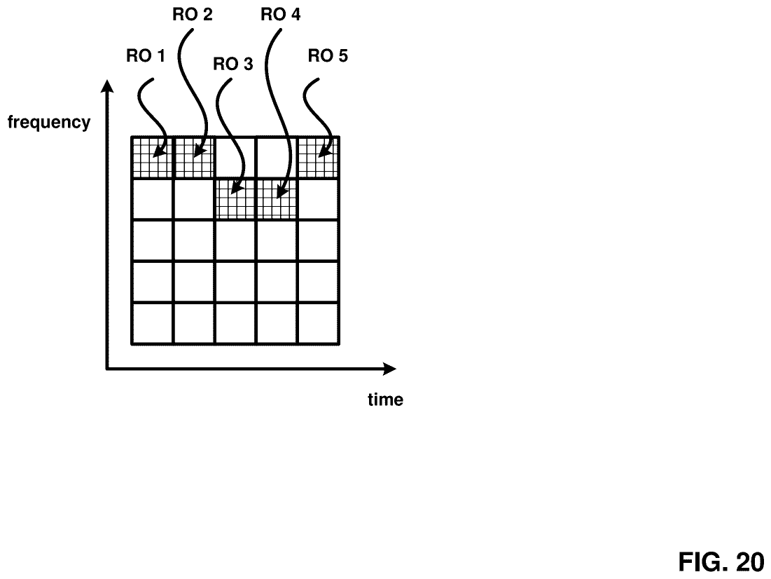

FIG. 20 shows an example diagram of time and frequency resources as per an aspect of an embodiment of the present disclosure. In the example of FIG. 20, an RO group (e.g., RO group 1, RO group 2, and the like) comprises a plurality of ROs. The plurality of ROs may comprise a first RO (e.g., RO 1 in FIG. 20). The plurality of ROs may comprise a second RO (e.g., RO 2 in FIG. 20). The plurality of ROs may comprise a third RO (e.g., RO 3 in FIG. 20). The plurality of ROs may comprise a fourth RO (e.g., RO 4 in FIG. 20). The plurality of ROs may comprise a fifth RO (e.g., RO 5 in FIG. 20).

The plurality of ROs may be based on/associated with a same reference signal (e.g., SSB, CSI-RS). For example, the one or more configuration parameters may indicate the plurality of ROs for/to be associated with/to correspond to a first reference signal (RS). For example, the one or more configuration parameters may comprise/indicate a table/mapping (e.g., SSB-to-RO mapping, ssb-perRACH-OccasionAndCB-PreamblesPerSSB, msgA-SSB-PerRACH-OccasionAndCB-PreamblesPerSSB, ssb-perRACH-Occasion, and the like) that indicates the plurality of ROs for/to be associated with/to correspond to with first RS.

The wireless device may determine the plurality of ROs for an RA procedure, for example, based on determining (e.g., selecting, choosing, picking, using, and the like) the first RS for the RA procedure.

In an example, the wireless device may be operating in/with/under (or the plurality of ROs may be for) a paired spectrum operation (e.g., frequency division duplex operation). Each/all RO(s), of the plurality of ROs, may be valid ROs, for example, based on the wireless device operating in (or based on the plurality of ROs being for) a paired spectrum (operation).

In an example, the wireless device may be operating in/with/under (or the plurality of ROs may be for) a supplementary uplink band. Each/all RO(s), of the plurality of ROs, may be valid ROs, for example, based on the wireless device operating in (or based on the plurality of ROs being for) the supplementary uplink band.

In an example, the wireless device may be operating in/with/under (or the plurality of ROs may be for) an unpaired spectrum operation (e.g., time division duplex operation). One or more ROs, of the plurality of ROs, may not be valid, for example, based on the wireless device operating in/with/under (or the plurality of ROs being for) an unpaired spectrum operation (e.g., time division duplex operation).

For example, in response to the one or more configuration parameters not comprising tdd-UL-DL-ConfigurationCommon, an RO, of the plurality of ROs, in a PRACH slot may be valid if it does not precede an RS (e.g., SSB, SS/PBCH block) in the PRACH slot and starts at least N_{gap} symbols after a last RS (e.g., SSB, SS/PBCH block) reception symbol, where N_{gap}={0, 2, 8, 16, and the like} and, if channelAccessMode=“semiStatic” is indicated in the one or more configuration parameters, the RO does not overlap with a set of consecutive symbols before the start of a next channel occupancy time where a wireless device does not transmit.

For example, in response to the one or more configuration parameters comprising the tdd-UL-DL-ConfigurationCommon, an RO, of the plurality of ROs, in a PRACH slot may be valid if: the RO is within uplink symbols, or the RO does not precede an RS (e.g., SSB, SS/PBCH block, and the like) in the PRACH slot and starts at least N_{gap} symbols after a last downlink symbol and at least N_{gap} symbols after a last SS/PBCH block symbol, where N_{gap}={0, 2, 8, 16, and the like}, and if channelAccessMode=“semiStatic” is provided, the RO does not overlap with a set of consecutive symbols before the start of a next channel occupancy time where there are no uplink transmissions.

In an example, the plurality of ROs shown in the example of FIG. 20 may be for paired spectrum (operation) and/or a supplementary uplink band. In response to the plurality of ROs shown in the example of FIG. 20 being for paired spectrum (operation) and/or a supplementary uplink band, each RO, of the plurality of ROs, (e.g., RO 1, RO 2, RO 3, RO 4, and RO 5) may be valid ROs (e.g., for/in an RO group).

In another example, the plurality of ROs shown in the example of FIG. 20 may be for unpaired spectrum (operation). In response to the plurality of ROs shown in the example of FIG. 20 being for unpaired spectrum (operation), one or more ROs, of the plurality of ROs, may not be valid (e.g., may be invalid) ROs (e.g., for/in an RO group). For example, a first RO (e.g., RO 3 in FIG. 20), of the plurality of ROs, may not be a valid (e.g., may be an invalid) RO (e.g., for/in the RO group). For example, the first RO (e.g., RO 3 in FIG. 20) may not be in/within uplink symbols of the unpaired spectrum. The first RO (e.g., RO 3 in FIG. 20) may not be a valid RO (e.g., may be an invalid RO in/for the RO group), for example, based on the first RO (e.g., RO 3 in FIG. 20) not being in/within the uplink symbols of the unpaired spectrum.

Based on the first RO (e.g., RO 3 in FIG. 20) not being a valid RO (e.g., being an invalid RO in/for the RO group), the wireless device may not transmit one or more RA preamble/PRACH repetitions/transmissions over/on/via the first RO.

In an example, the RO group may comprise the plurality of ROs. The plurality of ROs may comprise one or more valid ROs. The RO may be associated with/for/correspond to a first number of RA preamble/PRACH repetitions/transmissions. In an example, a number of valid ROs (e.g., a number of the one or more valid ROs) may be the same as (e.g., equal to, substantially equal to, and the like) the first number.

In the example of FIG. 20, the first number may be four. In the example of FIG. 20, the RO group may comprise five ROs (e.g., RO 1, RO 2, RO 3, RO 4, and RO 5). The RO group may comprise four valid ROs (e.g., RO 1, RO 2, RO 4, and RO 5). An RO (e.g., RO 3), of the plurality of ROs, may not be a valid RO (e.g., may be an invalid RO for/in the RO group). The RO group may be associated with four RA preamble/PRACH repetitions/transmissions. The RO group may comprise four valid ROs, for example, based on the RO group being associated with/for/corresponding to four RA preamble/PRACH repetitions/transmissions. The RO group may be associated with/for/correspond to four RA preamble/PRACH repetitions/transmissions, for example, based on the RO group comprising four valid ROs.

The wireless device may transmit/perform a number of RA preamble/PRACH repetitions/transmissions for an RA procedure. The wireless device may transmit/perform the number of RA preamble/PRACH repetitions/transmissions via/over/on one or more ROs, e.g., based on the number of RA preamble/PRACH repetitions/transmissions. For example, the number of RA preamble/PRACH repetitions/transmissions may be four. In the example of FIG. 19, the wireless device may transmit four RA preamble/PRACH repetitions/transmissions via/over/on RO 1, RO 2, RO 3, and RO 4. For example, the four RA preamble/PRACH repetitions/transmissions may comprise a first RA preamble/PRACH repetition/transmission, a second RA preamble/PRACH repetition/transmission, a third RA preamble/PRACH repetition/transmission, and a fourth RA preamble/PRACH repetition/transmission. The wireless device may transmit/perform the first RA preamble/PRACH repetition/transmission over/on/via/using RO 1. The wireless device may transmit/perform the second RA preamble/PRACH repetition/transmission over/on/via/using RO 2. The wireless device may transmit/perform the third RA preamble/PRACH repetition/transmission over/on/via/using RO 3. The wireless device may transmit/perform the fourth RA preamble/PRACH repetition/transmission over/on/via/using RO 4. A plurality of ROs may comprise RO 1, RO 2, RO 3, and RO 4. In an example, the plurality of ROs may be located in/at at least two time intervals (e.g., time durations, time slots, slots, sub-frames, and the like).

The wireless device may determine an RA-RNTI. The wireless device may use the RA-RNTI to receive an RA response (RA response). The RAR may correspond to the number of RA preamble/PRACH repetitions/transmissions (e.g., each/any/all RA preamble/PRACH repetition(s)/transmission(s) of the number of RA preamble/PRACH repetitions/transmissions). The wireless device may monitor/detect a PDCCH with/using the RA-RNTI to receive the RAR. For example, the wireless device may monitor the PDCCH (e.g., of a SpCell) for RAR(s) identified by the RA-RNTI (e.g., while a ra-Response Window is running).

In existing technologies, the wireless device may determine the RA-RNTI for RA preamble/PRACH repetitions/transmissions using/based on an RO, of a plurality of ROs, that is located last in time among the plurality of ROs. For example, in the existing technologies, the wireless device may consider only a time location (or only a frequency location) of the RO to determine the RA-RNTI. Time location can refer to relative location in time of the RO with respect to other ROs of a set or group of ROs, such as first in time or last in time. Similarly, frequency location can refer to relative location in frequency of the RO with respect to other ROs of a set or group of ROs, such as lowest frequency or highest frequency. For example, the wireless device may transmit four RA preamble/PRACH repetitions/transmissions via/over ROs from/of RO group 3 in the example of FIG. 18A. The wireless device may determine the RA-RNTI, for example, based on an RO that is located last in time in the RO group 3.

When there are a plurality of ROs that are located last in time (e.g., as shown in FIG. 19 where RO 2 and RO 3 are both last in time in/within an RO group), in the implementation of the existing technologies, the wireless device may not know which RO, of the plurality of ROs, to use for determining the RA-RNTI of/for/associated with the RA preamble/PRACH repetitions/transmissions or for the RA procedure. Using an incorrect RA-RNTI may result in the wireless device not being able to detect an RAR. This may lead to RA preamble/PRACH retransmissions, which result in additional signaling overhead, increase in latency, reduction in battery life, interference, excess power consumption, and/or wastage of network resources.

Embodiments of the present disclosure are related to an approach for determining an RA-RNTI for multiple/a plurality of RA preamble/PRACH repetitions/transmissions when there are a plurality of ROs that are located last in time (or in a last time slot). These and other features of the present disclosure are described further below.

In an example embodiment, a first plurality of ROs may be associated with/correspond to a first number of RA preamble/PRACH repetitions/transmissions. The first plurality of ROs may be located/occur in at least two time slots. The first plurality of ROs may comprise a second plurality of ROs. Each RO, of the second plurality of ROs, may be located last in time (e.g., in a last time slot of the at least two time slots) among the first plurality of ROs. In an example embodiment, the wireless device may determine an RA-RNTI for the first number of RA preamble/PRACH repetitions/transmissions based on/using an RO, of the second plurality of ROs, that is associated with a lowest index in frequency domain among the second plurality of ROs. In another example embodiment, the wireless device may determine an RA-RNTI for the first number of RA preamble/PRACH repetitions/transmissions based on/using an RO, of the second plurality of ROs, that is associated with a highest index in frequency domain among the second plurality of ROs.

Example embodiments of the present disclosure may provide enhancement for determining an RA-RNTI when transmitting/performing a plurality of/multiple RA preamble/PRACH repetitions/transmissions. Based on using an RO that is located last in time (or in a last time slot) and associated with a lowest (or highest) index in frequency domain, ambiguity in selecting an RO for determining the RA-RNTI may be reduced. Based on determining an RA-RNTI as per example embodiment(s) of the present disclosure, a wireless device and a base station may have a common understanding on determining the RA-RNTI. Having a common understanding may result in reduced RA preamble/PRACH repetitions/transmissions failure(s), reduced RA preamble/PRACH retransmissions, reduced signaling overhead, and/or increase in battery life of the wireless device.

A wireless device may receive one or more messages. The wireless device may receive the one or more messages from a base station. The base station may transmit the one or more messages. The base station may be, for example, a serving base station (e.g., a base station that serves a serving cell). The one or more messages may be radio resource control (RRC) messages (e.g., one or more RRC setup messages, one or more RRC reconfiguration messages, one or more RRC connection reestablishment messages, one or more RRC release messages, and the like). The one or more messages may be system information messages (e.g., one or more broadcast messages, one or more system information blocks (SIBs), and the like). In an example, the wireless device may receive the one or more messages from a relay node. In an example, the wireless device may receive the one or more messages from another wireless device (e.g., transmission and/or reception point (TRP), vehicle, remote radio head, and the like). In an example, the wireless device may receive the one or more messages from a non-terrestrial network payload (e.g., satellite, drone, uncrewed/unmanned aerial vehicle, and the like).

The one or more messages may comprise one or more configuration parameters. The one or more configuration parameters may be for a set/plurality of cells.

The set/plurality of cells may comprise a cell that may be, for example, a serving cell. The wireless device may receive the one or more messages via the cell. In an example, at least one configuration parameter of the one or more configuration parameters may be for the cell. In an example, the cell may be a primary cell (PCell). In an example, the cell may be a primary secondary cell (PSCell). In an example, the cell may be a secondary cell (SCell). The cell may be a secondary cell configured with PUCCH (e.g., PUCCH SCell). In an example, the cell may be a non-terrestrial network cell. In an example, the cell may be a special Cell (SpCell). For dual connectivity (DC) operation, the SpCell may refer to (or indicate) the PCell of the MCG or the PSCell of the SCG, otherwise the SpCell may refer to (or indicate) the PCell.

In an example, the cell may be an unlicensed (or shared spectrum channel access) cell, e.g., operating in an unlicensed band or operating with shared spectrum channel access. In an example, the cell may be a licensed cell, e.g., operating in a licensed band. In an example, the cell may operate in a first frequency range (FR1). The FR1 may, for example, comprise frequency bands below 6 GHz. In an example, the cell may operate in a second frequency range (FR2). The FR2 may, for example, comprise frequency bands from 24 GHz to 52.6 GHz. In an example, the cell may operate in a third frequency range (FR3). The FR3 may, for example, comprise frequency bands from 52.6 GHz to 71 GHz. The FR3 may, for example, comprise frequency bands starting from (or above) 52.6 GHz.

In an example, the wireless device may perform uplink transmissions (e.g., PUSCH, PUCCH, SRS) via/of/on/over/in the cell in a first time (e.g., time duration, time slot, and the like) and in a first frequency. The wireless device may perform downlink receptions (e.g., PDCCH, PDSCH) via/of the cell in a second time and in a second frequency. In an example, the cell may operate in a time-division duplex (TDD) mode. In the TDD mode, the first frequency and the second frequency may be the same. In the TDD mode, the first time and the second time may be different. In an example, the cell may operate in a frequency-division duplex (FDD) mode. In the FDD mode, the first frequency and the second frequency may be different (e.g., not the same). In the FDD mode, the first time and the second time may be the same (e.g., not different).

In an example, the wireless device may be in an RRC connected (RRC_CONNECTED) mode. In an example, the wireless device may be in an RRC idle (RRC_IDLE) mode. In an example, the wireless device may be in an RRC inactive (RRC_INACTIVE) mode.

In an example, the cell may comprise a plurality of BWPs. The plurality of BWPs may comprise one or more uplink BWPs comprising an uplink (UL) BWP of the cell. The plurality of BWPs may comprise one or more downlink BWPs comprising a downlink (DL) BWP of the cell.

In an example, a BWP of the plurality of BWPs may be in one of an active state and an inactive state (or a deactivated state). In an example, in the active state of a downlink BWP of the one or more downlink BWPs, the wireless device may monitor a downlink channel/signal (e.g., PDCCH, DCI, CSI-RS, PDSCH) on/for/via the downlink BWP. In an example, in the active state of a downlink BWP of the one or more downlink BWPs, the wireless device may receive a PDSCH on/via/for the downlink BWP. In an example, in the inactive state of a downlink BWP of the one or more downlink BWPs, the wireless device may not monitor a downlink channel/signal (e.g., PDCCH, DCI, CSI-RS, PDSCH) on/via/for the downlink BWP. In the inactive state of a downlink BWP of the one or more downlink BWPs, the wireless device may stop monitoring (or receiving) a downlink channel/signal (e.g., PDCCH, DCI, CSI-RS, PDSCH) on/via/for the downlink BWP. In an example, in the inactive state of a downlink BWP of the one or more downlink BWPs, the wireless device may not receive a PDSCH on/via/for the downlink BWP. In the inactive state of a downlink BWP of the one or more downlink BWPs, the wireless device may stop receiving a PDSCH on/via/for the downlink BWP.

The one or more configuration parameters may indicate a subcarrier spacing (or a numerology) for the downlink BWP.

The one or more configuration parameters may indicate a subcarrier spacing (or a numerology) for the uplink BWP.

A value of the subcarrier spacing (of the downlink BWP and/or the uplink BWP) may be/indicate, for example, 15 kHz (mu=0). A value of the subcarrier spacing may be/indicate, for example, 30 kHz (mu=1). A value of the subcarrier spacing may be/indicate, for example, 60 kHz (mu=2). A value of the subcarrier spacing may be/indicate, for example, 120 kHz (mu=3). A value of the subcarrier spacing may be/indicate, for example, 240 kHz (mu=4). A value of the subcarrier spacing may be/indicate, for example, 480 kHz (mu=5). A value of the subcarrier spacing may be/indicate, for example, 960 kHz (mu=6). For example, 480 kHz may be valid/applicable in FR3. For example, 960 kHz may be valid/applicable in FR3. For example, 240 kHz may be valid/applicable in FR3. For example, 120 kHz may be valid/applicable in FR3.

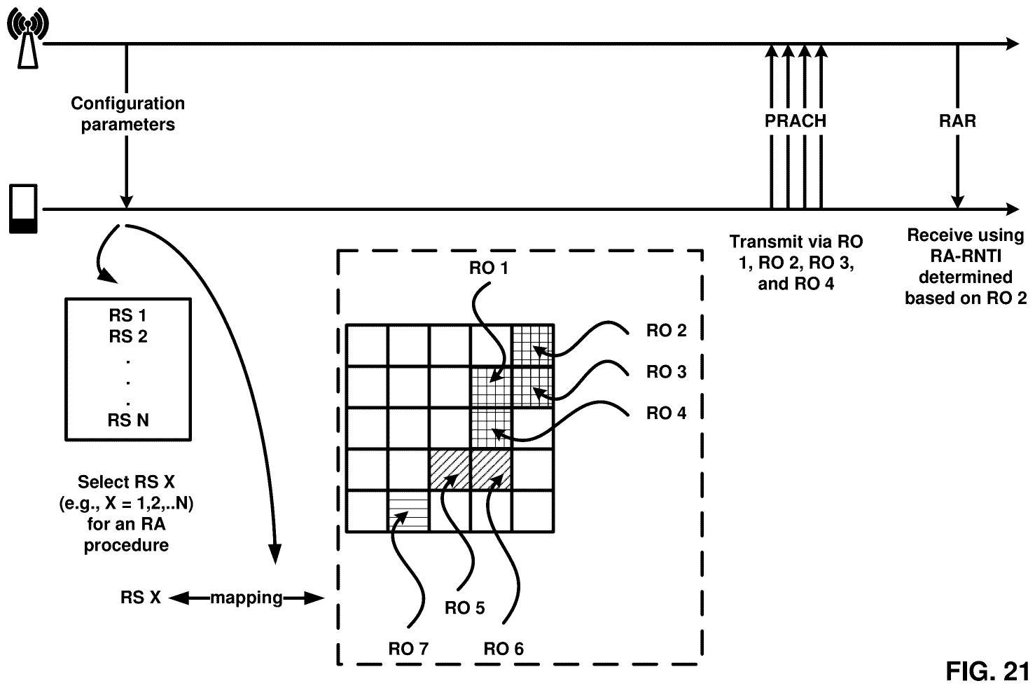

FIG. 21 illustrates an example timing diagram as per an aspect of an embodiment of the present disclosure. In the example of FIG. 21, the one or more configuration parameters may be represented as Configuration parameters.

The one or more configuration parameters may indicate one or more RSs. In the example of FIG. 21, the one or more RSs comprise a first RS (e.g., RS 1). The one or more RSs comprise a second RS (e.g., RS 2 in FIG. 21). The one or more RSs comprise an Nth (e.g., third) RS (e.g., RS N), where N={1, 2, 3 . . . 64, and the like}. In the example of FIG. 21, the one or more configuration parameters may indicate N (e.g., 4, 8, 16, 32, 64, and the like) RSs. For example, the one or more configuration parameters may comprise one or more fields indicating one or more indexes. Each index, of the one or more indexes, may be associated with (e.g., may identify/indicate) a respective RS of the one or more RSs. For example, the one or more indexes may comprise one or more SSB indexes. The one or more SSB indexes may identify one or more SSBs within a synchronization signal burst. In an example, the one or more indexes may comprise one or more CSI-RS indexes. The one or more CSI-RS indexes may indicate one or more CSI-RS resource indexes associated with/to one or more CSI-RS resources.

The one or more configuration parameters may indicate one or more ROs/RO groups for each RS, of the one or more RSs. For example, the one or more configuration parameters may comprise field(s) that indicate a mapping between each RS, of the one or more RSs, and the one or more ROs/RO groups. For example, the field(s) may be ssb-perRACH-OccasionAndCB-PreamblesPerSSB, msgA-SSB-PerRACH-OccasionAndCB-PreamblesPerSSB, ssb-perRACH-Occasion, ssb-PerRACH-OccasionTwoStepRA, prach-ConfigurationIndex, ssb-perRACH-OccasionGroupAndCB-PreamblesPerSSB, and the like.

In an example, the wireless device may determine (e.g., select, choose, pick, use, and the like) a first RS, of the one or more RSs, for an RA procedure. In the example of FIG. 21, the first RS may be RS X, where X may be one of 1, 2, . . . , or N. The wireless device may determine the first RS, for example, based on one or more radio link qualities of the one or more RSs. Each radio link quality, of the one or more radio link qualities may be associated with/of/for/correspond to a respective RS of the one or more RSs.

In some embodiments, a radio link quality may be, for example, a reference signal received power (RSRP). The radio link quality may be, for example, reference signal received quality (RSRQ). The radio link quality may be, for example, received signal strength indicator (RSSI). The radio link quality may be, for example, received signal power. The radio link quality may be, for example, received signal strength. The radio link quality may be, for example, signal to noise ratio. The radio link quality may be, for example, signal to noise plus interference ratio. The radio link quality may be, for example, block error rate.

For example, the wireless device may determine a first radio link quality of the first RS. The first radio link quality may be greater/higher/larger/more than (or equal to) a selection threshold (e.g., rsrp-ThresholdSSB, rsrp-ThresholdCSI-RS, msgA-RSRP-ThresholdSSB, rsrp-ThresholdSSB-SUL, and the like). The one or more configuration parameters may comprise/indicate the selection threshold. The selection threshold may be, for example, a radio link quality threshold for a selection of an RS for an RA procedure. If the RA procedure is initiated for beam failure recovery, the selection threshold used for the selection of the RS within candidateBeamRSList refers to the selection threshold in a BeamFailureRecoveryConfig IE (e.g., within/in/comprised in the one or more configuration parameters). The wireless device may determine (e.g., select, choose, pick, use, and the like) the first RS for the RA procedure, for example, based on the first radio link quality being greater/higher/larger/more than (or equal to) the selection threshold.

In another example, the wireless device may determine (e.g., select, choose, pick, use, and the like) the first RS for the RA procedure, for example, based on the first radio link quality being highest/greatest/largest/most among the one or more radio link qualities comprising the first radio link quality.

The wireless device may determine a plurality of ROs/RO groups associated with/mapped to/for/corresponding to the first RS. Each RO/RO group, of the plurality of ROs/RO groups, may be associated with/mapped to/for/corresponding to the first RS. In the example of FIG. 21, the plurality of ROs/RO groups may comprise RO 1, RO 2, RO 3, RO 4, RO 5, RO 6, and RO 7.

In the example of FIG. 21, the plurality of ROs/RO groups may comprise a first RO group (e.g., RO group 1 of FIG. 18B), a second RO group (e.g., RO group 2 of FIG. 18B), and a third RO group (e.g., RO group 3 of FIG. 18B).

In the example of FIG. 21, the first RO group may comprise one or more first ROs (e.g., RO 7 in FIG. 21). The second RO group may comprise one or more second ROs (e.g., RO 5 and RO 6 in FIG. 21). The third RO group may comprise one or more third ROs (e.g., RO 1, RO 2, RO 3, and RO 4 in FIG. 21). Each RO/RO group, of the plurality of ROs/RO groups, may be associated with/for/correspond to a respective number of RA preamble/PRACH repetitions/transmissions.

In the example of FIG. 21, the first RO group and/or the one or more first ROs may be associated with/for/correspond to a first number of RA preamble/PRACH repetitions/transmissions (e.g., 1). In the example of FIG. 21, the second RO group and/or the one or more second ROs may be associated with/for/correspond to a second number of RA preamble/PRACH repetitions/transmissions (e.g., 2). In the example of FIG. 21, the third RO group and/or the one or more third ROs may be associated with/for/correspond to a third number of RA preamble/PRACH repetitions/transmissions (e.g., 4).

A number of valid ROs comprised in/within an RO/RO group, of the plurality of ROs/RO groups, may be equal to the number of RA preamble/PRACH repetitions/transmissions associated with/corresponding to the RO/RO group.

For example, the first RO/RO group may comprise the first number of valid ROs, for example, based on the first RO group and/or the one or more first ROs being associated with/for/correspond to the first number of RA preamble/PRACH repetitions/transmissions (e.g., 1 in FIG. 21).

For example, the second RO/RO group may comprise the second number of valid ROs, for example, based on the second RO group and/or the one or more second ROs being associated with/for/correspond to the second number of RA preamble/PRACH repetitions/transmissions (e.g., 2 in FIG. 21).

For example, the third RO/RO group may comprise the third number of valid ROs, for example, based on the third RO group and/or the one or more third ROs being associated with/for/correspond to the third number of RA preamble/PRACH repetitions/transmissions (e.g., 4 in FIG. 21).

In an example, the wireless device may determine a number of RA preamble/PRACH repetitions/transmissions for an RA procedure. The RA procedure may be, for example, for/or/via/on the cell.

The wireless device may determine the number of RA preamble/PRACH repetitions/transmissions, for example, based on the first radio link quality of the first RS, one or more power thresholds (e.g., SSB-RSRP thresholds, CSI-RS-RSRP thresholds, and the like), and/or one or more offset values.

In an example, the number of RA preamble/PRACH repetitions/transmissions may be the third number. In response to determining the number of RA preamble/PRACH repetitions/transmissions as the third number, the wireless device may determine the third RO group (and/or the one or more third ROs) for transmitting/performing the number of RA preamble/PRACH repetitions/transmissions.

The wireless device may transmit/perform the number of RA preamble/PRACH repetitions/transmissions, for example, via/over/on one or more (valid) ROs that are comprised in the third RO group. In the example of FIG. 21, the one or more valid ROs may comprise RO 1, RO 2, RO 3, and RO 4. In the example of FIG. 21, the wireless device may transmit/perform the number of RA preamble/PRACH repetitions/transmissions via/over/on RO 1, RO 2, RO 3, and/or RO 4.

In an example, the wireless device may transmit each RA preamble/PRACH repetition/transmission of the number of RA preamble/PRACH repetitions/transmissions. In another example, the wireless device may not transmit one or more RA preamble/PRACH repetitions/transmissions, of the number of RA preamble/PRACH repetitions/transmissions, for example, due to/based on listen before talk (LBT) failure (e.g., based on not (being able to) access(ing) a channel (e.g., PRACH) within a sensing window). The wireless device may not transmit the one or more RA preamble/PRACH repetitions/transmissions, of the number of RA preamble/PRACH repetitions/transmissions, for example, based on receiving one or more LBT failure indications.

In another example, the wireless device may not transmit one or more RA preamble/PRACH repetitions/transmissions, of the number of RA preamble/PRACH repetitions/transmissions, for example, based on dropping the one or more RA preamble/PRACH repetitions/transmissions. The wireless device may drop the one or more RA preamble/PRACH repetitions/transmissions, for example, based on the one or more RA preamble/PRACH repetitions/transmissions having a lower priority than one or more uplink transmissions (e.g., PUSCH, PUCCH, SRS, and the like).

In response to (e.g., once, after, and the like) transmitting/performing the number of RA preamble/PRACH repetitions/transmissions, the wireless device may start/begin a time window (e.g., ra-Response Window, msgB-ResponseWindow, and the like). In response to (e.g., once, after, and the like) transmitting/performing the number of RA preamble/PRACH repetitions/transmissions, the wireless device may start/begin a time window (e.g., ra-ResponseWindow, msgB-Response Window, and the like), for example, regardless of the possible occurrence of a measurement gap.

The one or more configuration parameters may comprise/indicate the time window (e.g., a length of the time window). The wireless device may monitor a PDCCH for RA Response(s) identified by an RA-RNTI while the time window is running.

In the example of FIG. 21, the wireless device may receive an RAR using/based on the RA-RNTI.

In an example, the wireless device may determine the RA-RNTI based on an (valid) RO of the one or more (valid) ROs (e.g., one or more third ROs) comprised in the RO group (e.g., the third RO group) used for the transmitting/performing the number of RA preamble/PRACH repetitions/transmissions. In the example of FIG. 21, the wireless device may transmit/perform the number of RA preamble/PRACH repetitions/transmissions over/via/on RO 1, RO 2, RO 3, and/or RO 4. The one or more (valid) ROs may be located/occur in at least two time slots as shown in FIG. 21 and/or FIG. 19.

In an example, the wireless device may determine the RA-RNTI based on an equation. The equation may, for example, comprise s_id. For example, s_id may be an index of a first OFDM symbol of the (valid) RO, of the one or more (valid) ROs (e.g., the one or more third ROs). The equation may, for example, comprise t_id. For example, t_id may be an index of a first slot of the (valid) RO, of the one or more (valid) ROs, in a system frame.

The equation may, for example, comprise f_id. For example, f_id may be an index of the (valid) RO, of the one or more (valid) ROs, in the frequency domain. For example, f_id may be an index in the frequency domain of the (valid) RO of the one or more (valid) ROs.

In the example of FIG. 21, the wireless device may transmit/perform the number of RA preamble/PRACH repetitions/transmissions using/via/on/over the third RO group and/or the one or more (valid) ROs (e.g., one or more third ROs). The third RO group and/or the one or more (valid) ROs (e.g., one or more third ROs) may occur (e.g., be located) in at least two time slots.

For example, the one or more third ROs may comprise a first plurality of ROs. In the example of FIG. 21, the first plurality of ROs comprise RO 1 and RO 4. The one or more third ROs may comprise a second plurality of ROs. In the example of FIG. 21, the second plurality of ROs comprise RO 2 and RO 3. The first plurality of ROs occur at a first time slot. The second plurality of ROs occur at a second time slot. The first time slot may be different from the second time slot. For example, the second time slot may be after/located after/occur after/be placed after the first time slot. In an example, the first time slot and the second time slot may not overlap. In another example, the first time slot and the second time slot may partially overlap.

In an example, the second time slot may be a last time slot among the first time slot and the second time slot. The one or more third ROs may, for example, occur/be located at/in at least two time slots. The at least two time slots may comprise the first time slot. The at least two time slots may comprise the second time slot.

In an example, a time slot (e.g., the first time slot, the second time slot, each of the at least two time slots, and the like) may be at least one of: a time interval, an OFDM symbol, a symbol, a slot, a sub-frame, a time duration, a portion of a symbol, a portion of a slot, a portion of a sub-frame, a time period, and/or a time instance.

In an example, each (valid) RO of the one or more (valid) ROs (e.g., the one or more third ROs) may be associated with/have/correspond to a respective index in the frequency domain (e.g., f_id). In the example of FIG. 21, a first (valid) RO (e.g., RO 1), of the one or more (valid) ROs, may be associated with/have/correspond to a first index in the frequency domain (e.g., an index in the frequency domain of the first (valid) RO may be the first index in the frequency domain). A second (valid) RO (e.g., RO 2 in FIG. 21), of the one or more (valid) ROs, may be associated with/have/correspond to a second index in the frequency domain (e.g., an index in the frequency domain of the second (valid) RO may be the second index in the frequency domain). A third (valid) RO (e.g., RO 3 in FIG. 21), of the one or more (valid) ROs, may be associated with/have/correspond to a third index in the frequency domain (e.g., an index in the frequency domain of the third (valid) RO may be the third index in the frequency domain). A fourth (valid) RO (e.g., RO 4 in FIG. 21), of the one or more (valid) ROs, may be associated with/have/correspond to a fourth index in the frequency domain (e.g., an index in the frequency domain of the fourth (valid) RO may be the fourth index in the frequency domain).

In an example, the wireless device may determine the RA-RNTI using/based on an (valid) RO, of the one or more (valid) ROs (e.g., the one or more third ROs). In an example, the wireless device may determine the (valid) RO, of the one or more (valid) ROs, based on: the (valid) RO being located/occurring last in time among the one or more (valid) ROs (e.g., being located/occurring in a last time slot (e.g., the second time slot) among the at least two time slots) and/or the (valid) RO being associated with/having/corresponding to a lowest index in the frequency domain in the last time slot (e.g., the second time slot).

In an example, the second index in the frequency domain may be lower/lowest/smaller/smallest/least among the second index in the frequency domain and the third index in the frequency domain.

In the example of FIG. 21, the wireless device may determine the RA-RNTI based on the second (valid) RO (e.g., RO 2), for example, based on: the second (valid) RO (e.g., RO 2 in FIG. 21) being located/occurring last in time (e.g., being located/occurring at a last time slot, e.g., the second time slot) among the one or more (valid) ROs (e.g., the one or more third ROs, e.g., RO 1, RO 2, RO 3, RO 4 in FIG. 21); and the second index in the frequency domain being lowest/least/smallest among the second index in the frequency domain and the third index in the frequency domain.

In another example, the third index in the frequency domain may be lower/lowest/smaller/smallest/least among the second index in the frequency domain and the third index in the frequency domain. The wireless device may determine the RA-RNTI based on the third (valid) RO (e.g., RO 3), for example, based on: the third (valid) RO (e.g., RO 3 in FIG. 21) being located/occurring last in time (e.g., being located/occurring at a last time slot, e.g., the second time slot) among the one or more (valid) ROs (e.g., the one or more third ROs, e.g., RO 1, RO 2, RO 3, RO 4 in FIG. 21); and the third index in the frequency domain being lowest/least/smallest among the second index in the frequency domain and the third index in the frequency domain.

In an example, the lowest index (of a/an (valid) RO) in the frequency domain may not be the same as (e.g., may be different from) the index of a/an (valid) RO located lowest in frequency/frequency domain. For example, in FIG. 21, the second (valid) RO (e.g., RO 2) and the third (valid) RO (e.g., RO 3) may be located/occur last in time (e.g., be located/occurring at the last time slot (e.g., the second time slot) among the at least two time slots). The second index in the frequency domain may be, for example, lowest/smallest/least among the second index in the frequency domain and the third index in the frequency domain. A lowest index in the frequency domain (e.g., among the second index in the frequency domain and the third index in the frequency domain) may be the second index in the frequency domain, for example, based on the second index in the frequency domain being the lowest/smallest/least among the second index in the frequency domain and the third index in the frequency domain. An index in the frequency domain of an RO located/occurring in the lowest frequency/frequency domain may be the third index in the frequency domain, for example, based on the third (valid) RO (e.g., RO 3 in FIG. 21) being located/occurring lowest in frequency among the second (valid) RO (e.g., RO 2 in FIG. 21) and the third (valid) RO (e.g., RO 3 in FIG. 21).

In an example, the wireless device may determine the RA-RNTI using/based on a/an (valid) RO, of the one or more (valid) ROs (e.g., the one or more third ROs). In an example, the wireless device may determine the (valid) RO, of the one or more (valid) ROs, based on: the (valid) RO being located/occurring last in time among the one or more (valid) ROs (e.g., being located/occurring in a last time slot (e.g., the second time slot) among the at least two time slots) and/or the (valid) RO being associated with/having/corresponding to a highest index in the frequency domain in the last time slot (e.g., the second time slot).

In an example, the second index in the frequency domain may be highest/highest/larger/largest/most among the second index in the frequency domain and the third index in the frequency domain.

In the example of FIG. 21, the wireless device may determine the RA-RNTI based on the second (valid) RO (e.g., RO 2), for example, based on: the second (valid) RO (e.g., RO 2 in FIG. 21) being located/occurring last in time (e.g., being located/occurring at a last time slot, e.g., the second time slot) among the one or more (valid) ROs (e.g., the one or more third ROs, e.g., RO 1, RO 2, RO 3, RO 4 in FIG. 21); and the second index in the frequency domain being highest/largest/greatest among the second index in the frequency domain and the third index in the frequency domain.

In another example, the third index in the frequency domain may be highest/largest/greatest among the second index in the frequency domain and the third index in the frequency domain. The wireless device may determine the RA-RNTI based on the third (valid) RO (e.g., RO 3), for example, based on: the third (valid) RO (e.g., RO 3 in FIG. 21) being located/occurring last in time (e.g., being located/occurring at a last time slot, e.g., the second time slot) among the one or more (valid) ROs (e.g., the one or more third ROs, e.g., RO 1, RO 2, RO 3, RO 4 in FIG. 21); and the third index in the frequency domain being highest/largest/greatest among the second index in the frequency domain and the third index in the frequency domain.

In an example, the highest/largest/greatest index (of an/a (valid) RO) in the frequency domain may not be the same as the index (of a/an (valid) RO) located highest/largest/greatest in frequency/frequency domain. For example, in FIG. 21, the second (valid) RO (e.g., RO 2) and the third (valid) RO (e.g., RO 3) may be located/occur last in time (e.g., located/occurring at the last time slot (e.g., the second time slot) among the at least two time slots). The third index in the frequency domain may be, for example, highest/largest/greatest among the second index in the frequency domain and the third index in the frequency domain. A highest/largest/greatest index in the frequency domain (e.g., among the second index in the frequency domain and the third index in the frequency domain) may be the third index in the frequency domain, for example, based on the third index in the frequency domain being the highest/largest/greatest among the second index in the frequency domain and the third index in the frequency domain. An index in the frequency domain of an RO located/occurring in the highest/largest/greatest frequency/frequency domain may be the second index in the frequency domain, for example, based on the second (valid) RO (e.g., RO 3 in FIG. 21) being located/occurring highest/largest/greatest in frequency among the second (valid) RO (e.g., RO 2 in FIG. 21) and the third (valid) RO (e.g., RO 3 in FIG. 21).

Determining the RA-RNTI based on/using the (valid) RO associated with/having/corresponding to the lowest/least/smallest index (of the (valid) RO) in the frequency domain may be better than determining the RA-RNTI based on/using an index of the RO located in the lowest/least frequency, for example, based on/due to/because a location of the (valid) RO in frequency/frequency domain may be fixed but/and an index in the frequency domain of the (valid) RO may be dynamically changed by a base station. For example, in FIG. 21, one or more first configuration parameters (e.g., transmitted by the base station and received by the wireless device at a first time) may indicate a fifth index in the frequency domain for RO 2 and a sixth index in the frequency domain for RO 3. The fifth index in the frequency domain may be lowest among the fifth index in the frequency domain and the sixth index in the frequency domain (e.g., an index in the frequency domain of RO 2 may be less than an index in the frequency domain of RO 3). At a second/later time, the wireless device may receive one or more second configuration parameters that may indicate a seventh index in the frequency domain for RO 2 and an eighth index in the frequency domain for RO 3. The eighth index in the frequency domain may be the lowest among the seventh index in the frequency domain and the eighth index in the frequency domain (e.g., an index in the frequency domain of RO 3 may be less than an index in the frequency domain of RO 2). At the first time, an index in the frequency domain of RO 2 may be the lowest among respective indexes in the frequency domain of RO 2 and RO 3. At a second time, an index in the frequency domain of RO 3 may be the lowest among respective indexes in the frequency domain of RO 2 and RO 3. The RO that is located/occurs lowest in the frequency domain/frequency in FIG. 21 among RO 2 and RO 3 is RO 3 at both the first time and the second time. As a result, determining the RA-RNTI based on/using the RO associated with/having/corresponding to the lowest/least/smallest index (of the RO) in the frequency domain may be better than determining the RA-RNTI based on/using an index of the RO located in the lowest/least frequency. Determining the RA-RNTI based on/using the RO associated with/having/corresponding to the lowest/least/smallest index (of the RO) in the frequency domain may be better than determining the RA-RNTI based on/using an index of the RO located in the lowest/least frequency provides greater flexibility to a base station/network to vary RA-RNTI values that may be used for RAR reception.

In an example, the wireless device may determine the number of RA preamble/PRACH repetitions/transmissions to be the third number. Based on the number of RA preamble/PRACH repetitions/transmissions being the third number, the wireless device may determine the one or more (valid) ROs (e.g., the one or more third ROs) for transmitting/performing the number of RA preamble/PRACH repetitions/transmissions (e.g., the third number of RA preamble/PRACH repetitions/transmissions). In an example, the wireless device may determine the RA-RNTI based on: the (valid) RO that occurs/is located last in time (e.g., occurs/is located in a last time slot among at least two time slots); and is associated with the lowest index in the frequency domain in the last time slot. For example, in FIG. 21, the wireless device may determine the RA-RNTI based on RO 2 based on: RO 2 occurring/being located last among RO 1, RO 2, RO 3, and RO 4; and RO 2 being associated with an index in the frequency domain that is lowest among the respective index in the frequency domain of RO 2 and RO 3 (e.g., (valid) RO(s) that occur/are located last in time/in the last time slot among at least two time slots). In an example, the wireless device may transmit/perform an RA preamble/PRACH repetition/transmission, of the number of RA preamble/PRACH repetitions/transmissions, via/on/over/using/with RO 2. In another example, the wireless device may not transmit/perform (e.g., may skip, may drop, may not transmit due to LBT failure, and the like) an RA preamble/P RACH repetitions/transmissions, of the number of RA preamble/PRACH repetitions/transmissions, via/on/over/using/with RO 2.

In some embodiments, determining an RA-RNTI based on an/a (valid) RO may comprise determining (e.g., calculating, computing, estimating, and the like) the RA-RNTI using an index in the frequency domain of the (valid) RO (e.g., determining an RA-RNTI based on the second (valid) RO may comprise determining the RA-RNTI using the second index in the frequency domain) in the equation (e.g., as/for f_id).

In some embodiments, an RO group may be/comprise/refer to at least one of: a group of (valid) ROs, a set of (valid) ROs, a list of (valid) ROs, a table of (valid) ROs, an array of (valid) ROs, an/a (valid) RO set, a/an (valid) RO list, a/an (valid) RO table, a/an (valid) RO array, a bunch of (valid) ROs, a/an (valid) RO bunch, and/or the like.

In response to transmitting a number of RA preamble/PRACH repetitions/transmissions (e.g., the second number of RA preamble/PRACH repetitions/transmissions), the wireless device may receive an RAR using/based on the RA-RNTI. In response to receiving the number of RA preamble/PRACH repetitions/transmissions (e.g., the second number of RA preamble/PRACH repetitions/transmissions), the base station may transmit the RAR using/based on the RA-RNTI.

In response to a transmitting the number of RA preamble/PRACH repetitions/transmissions (e.g., the second number of RA preamble/PRACH repetitions/transmissions), the wireless device may attempt to detect a DCI format 10 with CRC scrambled the RA-RNTI during a time window (e.g., ra-Response Window). The time window may start at the first symbol of the earliest CORESET the wireless device is configured (e.g., by the one or more configuration parameters) to receive PDCCH for Type1-PDCCH common search space (CSS) set that is at least one symbol, after the last symbol of the valid RO corresponding to the number of RA preamble/PRACH repetitions/transmissions. If

$${N}_{TA , adj}^{UE} or {N}_{TA , adj}^{common}$$

advance used for uplink transmission(s) and k_{mac} is provided by k_{mac} (e.g., in/via the one or more configuration parameters) or k_{mac}=0 if k_{mac} is not provided (e.g., the one or more configuration parameters does not comprise/indicate k_{mac}). The length of the time window in number of slots may be provided by ra-Response Window (e.g., in/via the one or more configuration parameters).

If the wireless device detects the DCI format 10 with CRC scrambled by the RA-RNTI and LSBs of a SFN field in the DCI format 1_0, if included and applicable, are same as corresponding LSBs of the SFN where the wireless device transmitted the number of RA preamble/PRACH repetitions/transmissions, and the wireless device receives a transport block in a corresponding PDSCH within the time window, the wireless device may parse the transport block for a random access preamble identity (RAPID) associated with the number of RA preamble/PRACH repetitions/transmissions. If the wireless device identifies the RAPID in RAR message(s) of the transport block, higher layers (e.g., MAC layer) of the wireless device may indicate an uplink grant to a physical layer of the wireless device. This is referred to as random access response (RAR) UL grant in the physical layer of the wireless device.

If the wireless device does not detect the DCI format 10 with CRC scrambled by the RA-RNTI within the time window, or if the wireless device detects the DCI format 10 with CRC scrambled by the RA-RNTI within the time window and LSBs of a SFN field in the DCI format 1_0, if included and applicable, are not same as corresponding LSBs of the SFN where the wireless device transmitted the number of RA preamble/PRACH repetitions/transmissions, or if the wireless device does not correctly receive the transport block in the corresponding PDSCH within the time window, or if the wireless device does not identify the RAPID associated with the number of RA preamble/PRACH repetitions/transmissions from the wireless device, the wireless device may (re)transmit one or more RA preamble/PRACH repetitions/transmissions no later than N_{T,1}+0.75 msec after the last symbol of the time window, or the last symbol of the PDSCH reception, where N_{T,1} is a time duration of N₁ symbols corresponding to a PDSCH processing time for wireless device processing capability 1 assuming μ corresponds to the smallest SCS configuration among the SCS configurations for the PDCCH carrying the DCI format 1_0, the corresponding PDSCH when additional PDSCH DM-RS is configured, and the corresponding PRACH. For μ=0, the wireless device may assume N_{1,0}=14. For an RA preamble/PRACH repetition/transmission, of the number of RA preamble/PRACH repetitions/transmissions, using 1.25 kHz or 5 kHz SCS, the wireless device determines N₁ assuming SCS configuration μ=0.

In the present disclosure, an RO may refer to a time and/or frequency resource over/via/on which a wireless device may transmit/perform a RA preamble/PRACH repetition/transmission.

An RA-RNTI associated with an RO (or with a number of RA preamble/PRACH repetitions/transmissions) in which a RA preamble/PRACH repetitions/transmissions, of the number of RA preamble/PRACH repetitions/transmissions, is transmitted/performed may be determined/computed as: RA-RNTI=1+s_id+14×t_id+14×80×f_id+14×80×8×ul_carrier_id, where s_id is an index of a first OFDM symbol of an RO (0≤s_id<14), t_id is an index of the first slot of the RO in a system frame (0≤t_id<80), where the subcarrier spacing to determine t_id is based on the value of p specified in clause 5.3.2 in TS 38.211 for p={0, 1, 2, 3}, and for p={5, 6}, t_id is the index of the 120 kHz slot in a system frame that contains the RO (0≤t_id<80), f_id is the index of the RO in the frequency domain (0≤f_id<8), and uL_carrier_id is the UL carrier used for Random Access Preamble transmission (0 for NUL carrier, and 1 for SUL carrier), where the RO is located/occurs last in time (located/occurs in a last time slot) and/with a lowest f_id (e.g., for/among multiple/a plurality of RA preamble/PRACH repetitions/transmissions or PRACH transmission with repetitions).

For single cell operation with two uplink carriers or for operation with carrier aggregation, in response to a total wireless device transmit power for PUSCH or PUCCH or PRACH or SRS transmissions on serving cells in a frequency range in a respective transmission occasion i exceeding \hat{P}_{CMAX}(i), where \hat{P}_{CMAX}(i) is the linear value of P_{CMAX}(i) in transmission occasion i, the wireless device may allocate power to PUSCH/PUCCH/PRACH/SRS transmissions according to the following priority order (in descending order) so that the total wireless device transmit power for transmissions on serving cells in the frequency range is smaller than or equal to \hat{P}_{CMAX}(i) for that frequency range in every symbol of transmission occasion i:
PRACH transmission on a PCell;
PUCCH or PUSCH transmission with larger priority index;
For PUCCH or PUSCH transmissions with same priority index: PUCCH transmission with HARQ-ACK information, and/or scheduling request (SR), and/or link recovery request (LRR), or PUSCH transmission with HARQ-ACK information of the priority index; PUCCH transmission with CSI or PUSCH transmission with CSI; PUSCH transmission without HARQ-ACK information of the priority index or CSI and, for Type-2 random access procedure, PUSCH transmission on the PCell.
SRS transmission, with aperiodic SRS having higher priority than semi-persistent and/or periodic SRS, or PRACH transmission on a serving cell other than the PCell.

For the purpose of power allocation, in response to the one or more configuration parameters comprising uci-MuxWithDiffPrio and the wireless device multiplexing HARQ-ACK information in a PUSCH, a priority index of the PUSCH is the larger of (a) the priority index of the PUSCH according and (b) the larger priority index of the HARQ-ACK information. When determining a total wireless device transmit power for serving cells in a frequency range in a symbol of transmission occasion i, the wireless device may not include power for transmissions starting after the symbol of transmission occasion i. The total wireless device transmit power in a symbol of a slot is defined as the sum of the linear values of wireless device transmit powers for PUSCH, PUCCH, PRACH, and SRS in the symbol of the slot.

In case of same priority order and for operation with carrier aggregation, the wireless device may prioritize power allocation for transmissions on the primary cell of the master cell group (MCG) or the secondary cell group (SCG) over transmissions on a secondary cell. In case of same priority order and for operation with two uplink carriers, the wireless device may prioritize power allocation for transmissions on the carrier where the wireless device is configured to transmit PUCCH. If PUCCH is not configured for any of the two uplink carriers, the wireless device may prioritize power allocation for transmissions on the non-supplementary uplink carrier (e.g., normal uplink carrier, NUL, and the like).

For single cell operation or for operation with contiguous carrier aggregation in a same frequency band or for operation with non-contiguous carrier aggregation in a same frequency band if the one or more configuration parameters does not comprise intraBandNC-PRACH-simulTx-r17, the wireless device may not transmit PRACH and one or more uplink transmissions (e.g., PUSCH, PUCCH, SRS, and the like) (e.g., may drop the one or more uplink transmissions) in a same slot with respect to the smallest SCS configuration between the SCS configuration for the uplink BWP with the PRACH and the SCS configuration for the uplink BWP with the one or more uplink transmissions or when a gap between the first or last symbol of a PRACH transmission in a first slot is separated by less than N symbols from the last or first symbol, respectively, of the one or more uplink transmissions in a second slot where N=2 for μ=0 or μ=1, N=4 for μ=2 or μ=3, N=16 for μ=5, N=32 for μ=6, and μ is the smallest SCS configuration between the SCS configuration for the uplink BWP with the PRACH and the SCS configuration for the uplink BWP with the one or more uplink transmissions.

If the wireless device (e.g., HD-wireless device or RedCap wireless device) is configured by higher layers (e.g., MAC layer, RRC layer of the wireless device, by the one or more configuration parameters, and the like) to receive a PDCCH, or PDSCH, or CSI-RS, or DL PRS in a set of symbols, the wireless device may receive the PDCCH, or PDSCH, or CSI-RS, or DL PRS if the wireless device does not detect a DCI format that indicates to the wireless device to transmit a PUSCH, or PUCCH, or PRACH, or SRS in at least one symbol of the set of symbols; otherwise, the wireless device may not receive the PDCCH, or PDSCH, or CSI-RS, or DL PRS in the set of symbols.

If the wireless device would transmit a PRACH based on a detected DCI format, or PUSCH, or PUCCH, or SRS and the wireless device is indicated presence of SS/PBCH blocks within the active DL BWP by ssb-PositionsInBurst in SIB1 or in ServingCellConfigCommon or by NonCellDefiningSSB in a set of symbols, the wireless device does not transmit PUSCH or PUCCH or PRACH if a transmission would overlap with any symbol from the set of symbols and the wireless device does not transmit SRS in the set of symbols.

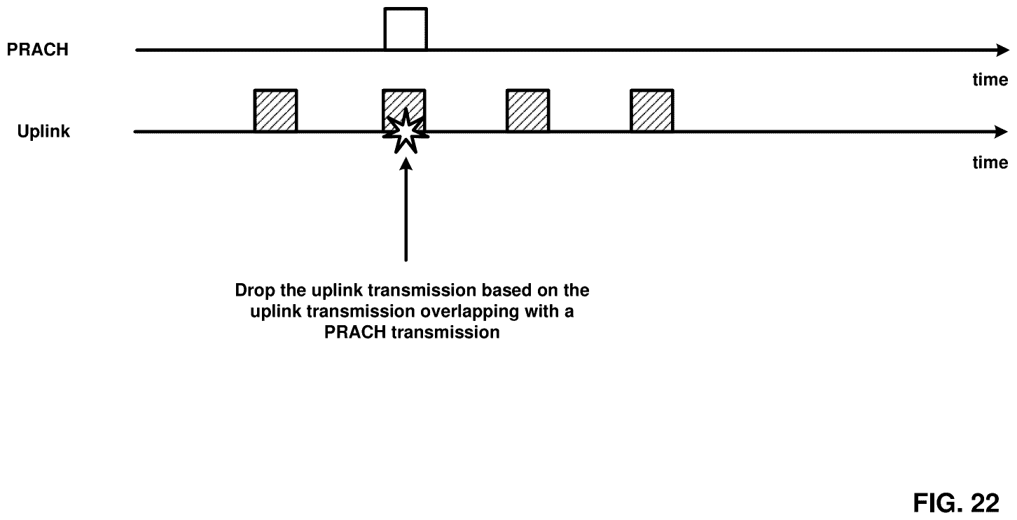

FIG. 22 illustrates an example of one or more uplink transmissions as per an aspect of an embodiment of the present disclosure. In the example of FIG. 22, one or more uplink transmissions (e.g., PUSCH, PUCCH, SRS, PRACH, and the like) may overlap in time with an RA preamble/PRACH transmission. In the example of FIG. 22, the one or more uplink transmissions comprise a first uplink transmission, a second uplink transmission, a third uplink transmission, and a fourth uplink transmission. In the example of FIG. 22, the second uplink transmission may overlap in time with the RA preamble/PRACH transmission. In response to the second uplink transmission overlapping with the RA preamble/PRACH transmission, the wireless device may drop (e.g., not transmit, skip transmitting, and the like) the second uplink transmission. The wireless device may transmit the first uplink transmission, the third uplink transmission, and/or the fourth uplink transmission, for example, based on the first uplink transmission, the third uplink transmission, and/or the fourth uplink transmission (each) not overlapping in time with the RA preamble/PRACH transmission. In an example, the wireless device may drop uplink transmission(s), of the one or more uplink transmissions, based on/as/using one or more conditions described in the above paragraphs.

In existing technologies, a wireless device may drop one or more uplink transmissions (e.g., PUSCH, PUCCH, SRS) based on the one or more uplink transmissions overlapping with a RA preamble/PRACH transmission or when a gap between the first or last symbol of the RA preamble/PRACH transmission in a first slot is separated by less than N symbols from the last or first symbol, respectively, of the one or more uplink transmissions in a second slot. When using a plurality of RA preamble/PRACH repetitions/transmissions, in the implementation of the existing technologies, the wireless device may drop the one or more uplink transmissions that overlaps with at least one RA preamble/PRACH repetition/transmission, of the plurality of RA preamble/PRACH repetitions/transmissions, or when the gap between the first or last symbol of one or more RA preamble/PRACH repetition/transmission, of the plurality of RA preamble/PRACH repetitions/transmissions, in a first slot is separated by less than N symbols from the last or first symbol, respectively, of the one or more uplink transmissions in a second slot.

The implementation of the existing technologies may result in unnecessarily dropping uplink transmission(s) of the one or more uplink transmissions (e.g., PUSCH, PUCCH, SRS, and the like). Dropping uplink transmission(s), of the one or more uplink transmissions, may result in increase in latency. For example, the wireless device may (attempt to) retransmit the one or more uplink transmissions at a later time.

Embodiments of the present disclosure are related to an approach for dropping one or more uplink transmissions and/or one or more RA preamble/PRACH repetitions/transmissions, when using a plurality of/multiple RA preamble/PRACH repetitions/transmissions. These and other features of the present disclosure are described further below.

In an example embodiment, in response to using/transmitting/performing a plurality of/multiple RA preamble/PRACH repetitions/transmissions, the wireless device may drop one or more RA preamble/PRACH repetitions/transmissions, of the plurality of RA preamble/PRACH repetitions/transmissions, based on one or more uplink transmissions overlapping in time with the one or more RA preamble/PRACH repetitions/transmissions in/for not more than/at most X (X=1, 2, 3, half of the plurality of RA preamble/PRACH repetitions/transmissions, 10% of the plurality of RA preamble/PRACH repetitions/transmissions, and the like) time slots (e.g., slots, time intervals, time durations, sub-frames, symbols, OFDM symbols, and the like). In response to the one or more uplink transmissions overlapping in time with the one or more RA preamble/PRACH repetitions/transmissions, of the plurality of RA preamble/PRACH repetitions/transmissions, in/for more than X time slots, the wireless device may drop the one or more uplink transmissions (e.g., all of the one or more uplink transmission, or the uplink transmission(s) of the one or more uplink transmissions, that overlap in time with the one or more RA preamble/PRACH repetitions/transmissions).

In an example embodiment, in response to using/transmitting/performing a plurality of/multiple RA preamble/PRACH repetitions/transmissions, the wireless device may drop one or more RA preamble/PRACH repetitions/transmissions, of the plurality of RA preamble/PRACH repetitions/transmissions, based on a gap between the first or last symbol of the Xth (where X=2, 3, 4, the plurality −1, and the like) RA preamble/PRACH repetition/transmission, of the plurality of RA preamble/PRACH repetitions/transmissions, in a first slot is separated by less than N symbols from the last or first symbol, respectively, of the one or more uplink transmissions in a second slot.

Example embodiments of the present disclosure may provide enhancement for dropping one or more uplink transmissions (e.g., PUSCH, PUCCH, SRS, and the like) that overlap with one or more RA preamble/PRACH repetitions/transmissions. Based on not dropping (e.g., skipping dropping) the one or more uplink transmissions in response to the one or more uplink transmissions overlapping in time with one or more RA preamble/PRACH repetitions/transmissions, of a plurality of RA preamble/PRACH repetitions/transmissions, in at most X (X=1, 2, 3, half of the plurality of RA preamble/PRACH repetitions/transmissions, 10% of the plurality of RA preamble/PRACH repetitions/transmissions, and the like) time slots, the wireless device may improve latency of the one or more uplink transmission.

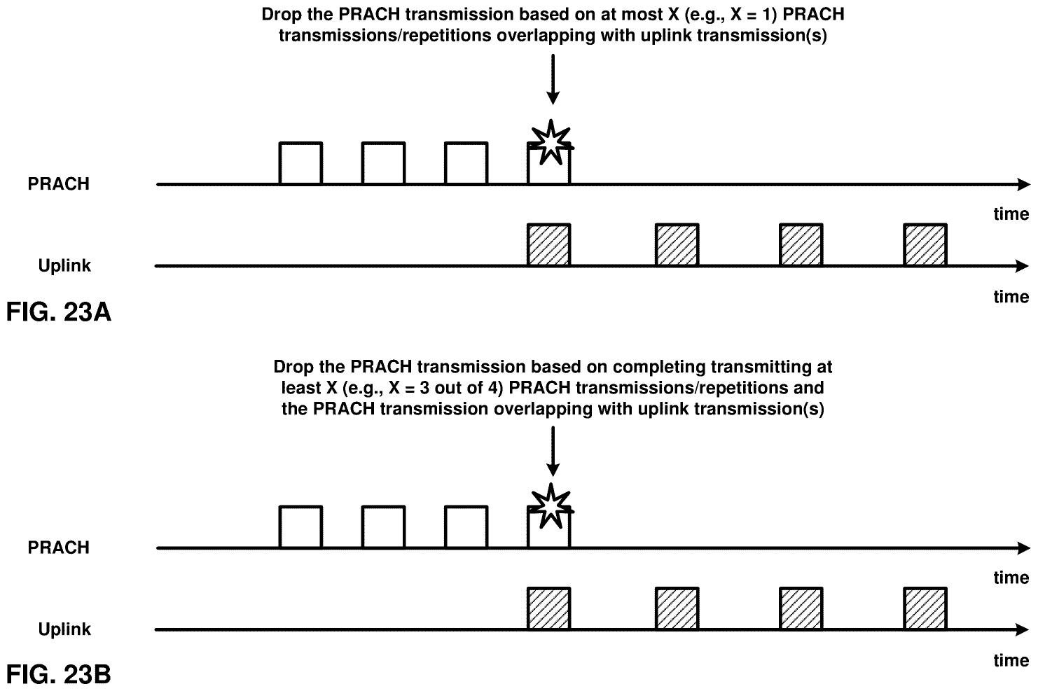

FIG. 23A illustrates an example timing diagram as per an aspect of an embodiment of the present disclosure. In the example of FIG. 23A, the wireless device may determine a plurality of RA preamble/PRACH repetitions/transmissions for an RA procedure (e.g., of/for/via a cell). For example, the wireless device may determine the plurality of RA preamble/PRACH repetitions/transmissions, for the RA procedure, based on a radio link quality (e.g., RSRP, RSRQ, signal to noise ratio, received signal strength indication, received power, signal strength, block error rate, and the like) of an RS (e.g., SSB. CSI-RS, PRS, SRS, and the like). The wireless device may determine (e.g., select, choose, pick, apply, use, and the like) the RS for the RA procedure.

In the example of FIG. 23A, the plurality of RA preamble/PRACH repetitions/transmissions may be four RA preamble/PRACH repetitions/transmissions.

In an example embodiment, the wireless device may drop (e.g., skip transmitting, drop transmitting, not transmit, avoid, avoid transmitting, and the like) one or more RA preamble/PRACH repetitions/transmissions of the plurality of RA preamble/PRACH repetitions/transmissions. The wireless device may drop one or more RA preamble/PRACH repetitions/transmissions, of the plurality of RA preamble/PRACH repetitions/transmissions, for example, based on the one or more RA preamble/PRACH repetitions/transmissions overlapping in time with one or more uplink transmissions.

In an example, the wireless device may receive one or more messages (e.g., RRC messages MAC CE, DCI, and the like) scheduling/indicating the one or more uplink transmissions. For example, the one or more uplink transmissions may be one or more configured grant (e.g., Type-1 configured grant, Type-2 configured grant) uplink transmissions. The one or more uplink transmissions may be, for example, one or more PUSCH transmissions. The one or more uplink transmissions may be, for example, one or more PUCCH transmissions. The one or more uplink transmissions may be, for example, one or more SRS transmissions (e.g., positioning SRS transmissions, periodic SRS transmissions, aperiodic SRS transmissions, semi-persistent SRS, and the like). The one or more uplink transmissions may be, for example, one or more small data transmissions (e.g., configured grant small data transmission, RA-small data transmissions, and the like). The one or more uplink transmissions may be, for example, one or more RA message transmissions (e.g., Msg 1, RA preamble/PRACH repetitions/transmissions, Msg3, Msg3 PUSCH, Msg4 HARQ-ACK, Msg5, and the like). The one or more uplink transmissions may be, for example, one or more PUCCH transmissions without dedicated PUCCH resources (e.g., PUCCH transmissions using common PUCCH resources). The one or more uplink transmissions may be, for example, one or more PUCCH transmissions over/using/with dedicated PUCCH resources. The one or more uplink transmissions may be, for example, one or more wireless device capability message transmissions.

In the example of FIG. 23A, the plurality of RA preamble/PRACH repetitions/transmissions comprises a first RA preamble/PRACH repetition/transmission, a second RA preamble/PRACH repetition/transmission, a third RA preamble/PRACH repetition/transmission, and a fourth RA preamble/PRACH repetition/transmission. In the example of FIG. 23A, the one or more uplink transmissions comprise a first uplink transmission, a second uplink transmission, a third uplink transmission, and a fourth uplink transmission.

In the example of FIG. 23A, the one or more RA preamble/PRACH repetitions/transmissions (e.g., the fourth RA preamble/PRACH repetition/transmission), of the plurality of RA preamble/PRACH repetitions/transmissions, overlaps in time with uplink transmission(s) (e.g., the first uplink transmission), of the one or more uplink transmissions. In an example, the one or more RA preamble/PRACH repetitions/transmissions may fully overlap in time with the uplink transmission(s). In another example, the one or more RA preamble/PRACH repetitions/transmissions may partially overlap in time with the uplink transmission(s).

The wireless device may drop the one or more RA preamble/PRACH repetitions/transmissions that overlap(s) in time with the uplink transmission(s), for example, based on the one or more RA preamble/PRACH repetitions/transmissions overlapping in time with the uplink transmission(s) for at most X (where X=1, 2, 3, half of the plurality, the plurality −1, and the like) time slots (e.g., time intervals, symbols, slots, sub-frames, time durations, OFDM symbols, and the like).

The wireless device may drop the one or more RA preamble/PRACH repetitions/transmissions that overlaps in time with the uplink transmission(s), for example, based on at most X (where X=1, 2, 3, half of the plurality, 10% of the plurality, the plurality −1, and the like) RA preamble/PRACH repetition(s)/transmission(s), of the plurality of RA preamble/PRACH repetitions/transmissions, overlapping in time with the uplink transmission(s).

In an example, X may be preconfigured. In an example, the one or more configuration parameters may indicate/comprise X. In an example, the one or more configuration parameters may comprise a field indicating (a value of) X.

FIG. 23B illustrates an example timing diagram as per an aspect of an embodiment of the present disclosure. In the example of FIG. 23B, the plurality of RA preamble/PRACH repetitions/transmissions may comprise a first RA preamble/PRACH repetition/transmission, a second RA preamble/PRACH repetition/transmission, a third RA preamble/PRACH repetition/transmission, and a fourth RA preamble/PRACH repetition/transmission.

The wireless device may transmit the first RA preamble/PRACH repetition/transmission, for example, based on the first RA preamble/PRACH repetition/transmission not overlapping with (any of) the one or more uplink transmissions.

The wireless device may transmit the second and/or third RA preamble/PRACH repetition/transmission, for example, based on the second and/or third RA preamble/PRACH repetition/transmission not overlapping with (any of) the one or more uplink transmission.

In the example of FIG. 23B, the fourth RA preamble/PRACH repetition/transmission may overlap (e.g., either partially or fully) in time with uplink transmission(s) of the one or more uplink transmissions. The wireless device may drop one or more RA preamble/PRACH repetitions/transmissions (e.g., the fourth RA preamble/PRACH repetition/transmission), for example, based on (already completing) transmitting at least X RA preamble/PRACH repetitions/transmissions of the plurality of RA preamble/PRACH repetitions/transmissions. In the example of FIG. 23B, X may be 3 or 3 out of 4.

In the example of FIG. 23B, the fourth RA preamble/PRACH repetition/transmission may overlap (e.g., either partially or fully) in time with uplink transmission(s) of the one or more uplink transmissions. The wireless device may drop one or more RA preamble/PRACH repetitions/transmissions (e.g., the fourth RA preamble/PRACH repetition/transmission), for example, based on at least X RA preamble/PRACH repetitions/transmissions, of the plurality of RA preamble/PRACH repetitions/transmissions, not overlapping with uplink transmission(s) of the one or more uplink transmissions.

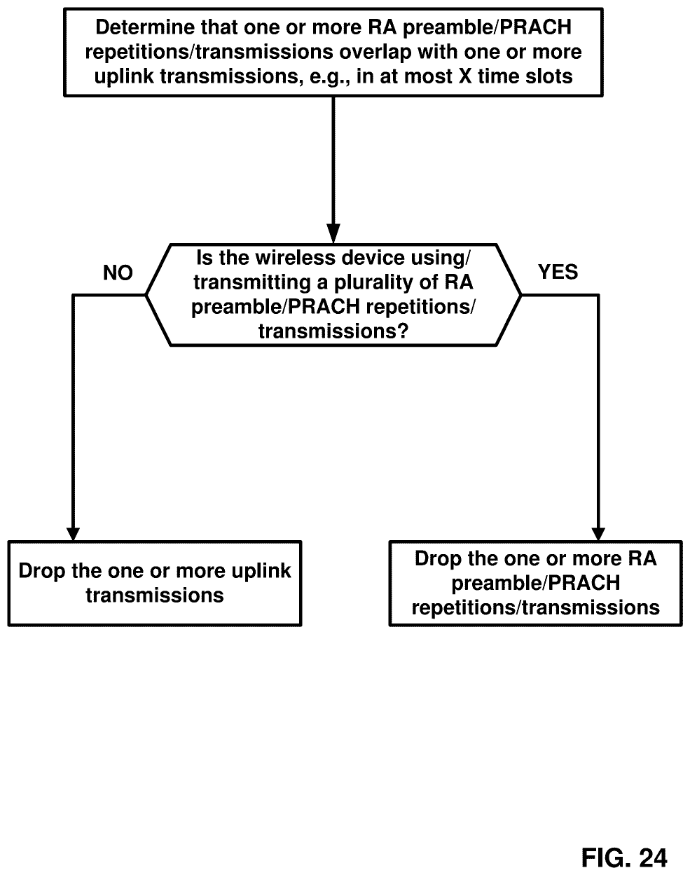

FIG. 24 illustrates an example flow diagram as per an aspect of an embodiment of the present disclosure. In the example of FIG. 24, the wireless device may determine that one or more RA preamble/PRACH repetitions/transmissions may overlap in time with one or more uplink transmissions in at most X time slots.

In an example, the wireless device may determine a plurality of RA preamble/PRACH repetitions/transmissions for an RA procedure. In response to determining/using/transmitting/performing the plurality of RA preamble/PRACH repetitions/transmissions for the RA procedure, the wireless device may (determine to) drop the one or more RA preamble/PRACH repetitions/transmissions, of the plurality of RA preamble/PRACH repetitions/transmissions, that overlap with the one or more uplink transmissions.

In another example, the wireless device may determine a single RA preamble/PRACH repetition/transmission for the RA procedure. The one or more RA preamble/PRACH repetition/transmission may comprise the single RA preamble/PRACH repetition/transmission. In response to determining/using/transmitting/performing the single RA preamble/PRACH repetition/transmission, the wireless device may not drop the single RA preamble/PRACH repetition/transmission. In response to determining/using/transmitting/performing the single RA preamble/PRACH repetition/transmission, the wireless device may drop the one or more uplink transmissions that overlap in time with the one or more RA preamble/PRACH repetition/transmission (e.g., the single RA preamble/PRACH repetition/transmission).

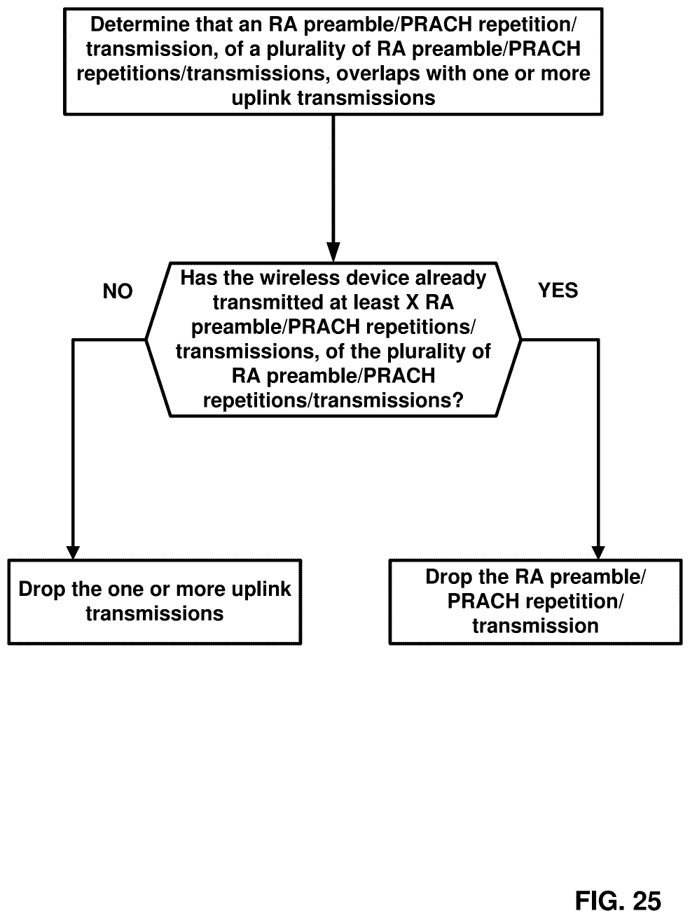

FIG. 25 illustrates an example flow diagram as per an aspect of an embodiment of the present disclosure. In the example of FIG. 25, the wireless device may determine a plurality of RA preamble/PRACH repetitions/transmissions for an RA procedure.

The wireless device may determine that an RA preamble/PRACH repetition/transmission, of the plurality of RA preamble/PRACH repetitions/transmissions, overlaps (e.g., either fully or partially) in time with uplink transmission(s) of one or more uplink transmissions.

In an example, the wireless device may determine whether to drop the RA preamble/PRACH repetition/transmission, of the plurality of RA preamble/PRACH repetitions/transmissions, or the uplink transmission(s), of the one or more uplink transmissions, for example, based on whether the wireless device has (already completed) transmitted/performed at least X (where X=1, 2, 3, half the plurality, the plurality −1, and the like) RA preamble/PRACH repetitions/transmissions, of the plurality of RA preamble/PRACH repetitions/transmissions.

In an example, the wireless device may transmit/perform at least X RA preamble/PRACH repetitions/transmissions, of the plurality of RA preamble/PRACH repetitions/transmissions, before/prior to the RA preamble/PRACH repetition/transmission that overlaps with the uplink transmission(s). The wireless device may determine to drop the RA preamble/PRACH repetition/transmission, of the plurality of RA preamble/PRACH repetitions/transmissions, based on/in response to: the RA preamble/PRACH repetition/transmission, of the plurality of RA preamble/PRACH repetitions/transmissions, overlapping in time with the uplink transmission(s) and/or the wireless device transmitting/performing at least X RA preamble/PRACH repetitions/transmissions, of the plurality of RA preamble/PRACH repetitions/transmissions, before/prior to the RA preamble/PRACH repetition/transmission.

In another example, the wireless device may not transmit/perform at least X RA preamble/PRACH repetitions/transmissions, of the plurality of RA preamble/PRACH repetitions/transmissions, before/prior to the RA preamble/PRACH repetition/transmission that overlaps with the uplink transmission(s). For example, the wireless device may transmit/perform fewer than X RA preamble/PRACH repetitions/transmissions, of the plurality of RA preamble/PRACH repetitions/transmissions, before/prior to the RA preamble/PRACH repetition/transmission that overlaps with the uplink transmission(s). The wireless device may drop the uplink transmission(s), for example, based on: the RA preamble/PRACH repetition/transmission, of the plurality of RA preamble/PRACH repetitions/transmissions overlapping in time with the uplink transmission(s) and/or the wireless device not transmitting/performing at least X RA preamble/PRACH repetitions/transmissions, of the plurality of RA preamble/PRACH repetitions/transmissions, before/prior to the RA preamble/PRACH repetition/transmission that overlaps with the uplink transmission(s) (e.g., the wireless device transmitting/performing fewer than X RA preamble/PRACH repetitions/transmissions, of the plurality of RA preamble/PRACH repetitions/transmissions, before/prior to the RA preamble/PRACH repetition/transmission that overlaps with the uplink transmission(s)).

In an example, X may be one. In an example, X may be one less than the plurality of RA preamble/PRACH repetitions/transmissions. For example, the plurality of RA preamble/PRACH repetitions/transmissions may comprise four RA preamble/PRACH repetitions/transmissions. X may be three, for example, based on the plurality of RA preamble/PRACH repetitions/transmissions comprising four RA preamble/PRACH repetitions/transmissions.

In an example, the one or more configuration parameters may comprise/indicate X. For example, the one or more configuration parameters may comprise a field indicating X (or a value of X). X may be referred to as, for example, maxOverlapPRACH-SRS, maxOverlapPRACH-PUCCH, maxOverlapPRACH-PUSCH, and the like.

In some embodiments, dropping one or more RA preamble/PRACH repetitions/transmissions, of a plurality of RA preamble/PRACH repetitions/transmissions, may comprise not transmitting/performing the one or more RA preamble/PRACH repetitions/transmissions. In some embodiments, dropping the one or more RA preamble/PRACH repetitions/transmissions, of the plurality of RA preamble/PRACH repetitions/transmissions, may comprise transmitting/performing RA preamble/PRACH repetition(s)/transmission(s) (e.g., remaining RA preamble/PRACH repetition(s)/transmission(s)), of the plurality of RA preamble/PRACH repetitions/transmissions, other than the one or more RA preamble/PRACH repetitions/transmissions.

In some embodiments, dropping uplink transmission(s), of one or more uplink transmissions, may comprise not transmitting/performing the uplink transmission(s), of the one or more uplink transmissions. In some embodiments, dropping the uplink transmission(s), of the one or more uplink transmissions may comprise transmitting/performing second uplink transmission(s) (e.g., remaining uplink transmissions of the one or more uplink transmissions), of the one or more uplink transmissions, other than the uplink transmission(s).

In an example, the wireless device may transmit/perform the plurality of RA preamble/PRACH repetitions/transmissions in/via a first cell. The wireless device may transmit/perform the one or more uplink transmissions in/via a second cell. In an example, the first cell may be the same as the second cell. In an example, the first cell may be different from the second cell. The first cell and second cell may be/have/comprise/associated with, for example, contiguous carrier aggregation in a same frequency band. In an example, the first cell and the second cell may be/have/comprise/associated with non-contiguous carrier aggregation in same frequency band.

In an example, the wireless device may, e.g., drop the one or more RA preamble/PRACH repetitions/transmissions, as per example embodiments of FIG. 23A, FIG. 23B, FIG. 24, and/or FIG. 25, further based on the one or more RA preamble/PRACH repetitions/transmissions having lower priority than the one or more uplink transmissions (and/or the uplink transmission(s) of the one or more uplink transmissions).

For single cell operation or for operation with contiguous carrier aggregation in a same frequency band or for operation with non-contiguous carrier aggregation in a same frequency band, if the wireless device is not provided (e.g., in/via the one or more configuration parameters) with intraBandNC-PRACH-simulTx-r17, the wireless device transmits multiple (e.g., a plurality of) RA preamble/PRACH repetitions/transmissions (e.g., for the RA procedure), and an RA preamble/PRACH repetition/transmission (e.g., of the plurality of RA preamble/PRACH repetitions/transmissions) overlaps with a PUSCH/PUCCH/SRS in at most one slot with respect to the smallest SCS configuration between the SCS configuration for the UL BWP with the PRACH and the SCS configuration for the UL BWP with the PUSCH/PUCCH/SRS transmissions, the wireless device may drop the RA preamble/PRACH repetition/transmission, of the plurality of RA preamble/PRACH repetitions/transmissions.

Layer-1/2 triggered mobility (LTM) may be referred to as lower layer triggered mobility. LTM is a procedure in which a base station (e.g., gNB, cell, network, CU, DU, source DU, candidate/target DU, and the like) may receive one or more layer 1/2 (L-1/2), e.g., physical layer, medium access control (MAC) layer, lower layer, and the like, measurement reports from wireless devices. Based on (or on the basis of receiving) the one or more L-1/2 measurement reports (the one or more L-1/2 measurement reports may be referred to as one or more (L-1/2) measurements), the base station may change/switch a wireless device's serving cell(s) through/via/using an L-1/2 command (e.g., medium access control (MAC) control element (CE), L-1/2 control command, DCI, PDCCH, cell switch MAC CE, LTM command MAC CE, LTM cell switch command MAC CE, and the like). The base station may prepare (e.g., indicate to the wireless device) one or more candidate/target cells, e.g., for LTM.

The one or more candidate/target cells may be referred to as one or more LTM candidate/target cells. The one or more candidate/target cells may comprise one or more serving cells. The one or more candidate/target cells may comprise one or more (candidate/target) non-serving cells. The one or more candidate/target cells may comprise one or more (candidate/target) SCells. The one or more candidate/target cells may comprise one or more (candidate/target) activated SCells. The one or more candidate/target cells may comprise one or more (candidate/target) deactivated SCells.

The base station may provide, e.g., for LTM (or an LTM procedure/process), one or more candidate/target (LTM) cell configurations to the wireless device through/via one or more messages (e.g., RRC message(s)). The one or more messages may comprise one or more configuration parameters (e.g., RRC configuration parameters). The one or more messages may indicate the one or more candidate/target cells. The one or more candidate/target (LTM) cell configurations may be for/indicate/associated with/of the one or more candidate/target cells. Each candidate/target (LTM) cell configuration may be for/indicate/associated with a respective candidate/target cell of the one or more candidate/target cells. Then (e.g., after the wireless device receives the one or more messages) an LTM cell switch may be triggered (e.g., by the base station/gNB), by selecting one candidate/target (LTM cell) configuration, of the one or more candidate/target (LTM cell) configurations, as a target (LTM cell) configuration for LTM by the base station. The one or more candidate/target (LTM cell) configurations may be added by the network/base station via RRC signaling. The one or more candidate/target (LTM cell) configurations may be modified by the network/base station via RRC signaling. The one or more candidate/target (LTM cell) configurations may be released by the network/base station via RRC signaling.

In an example, the one or more candidate/target (LTM cell) configurations may be/comprise one or more RRCReconfigurations (messages). Each RRCReconfiguration of the one or more RRCReconfigurations may be for/associated with a respective candidate/target cell of the one or more candidate/target cells. In an example, the one or more candidate/target (LTM cell) configurations may be/comprise one or more CellGroupConfig information elements (IEs). Each CellGroupConfig IE of the one or more CellGroupConfig IEs may be for/associated with a respective candidate/target cell of the one or more candidate/target cells.

In LTM, the one or more candidate/target (LTM cell) configurations may be provided (e.g., transmitted by the base station to the wireless device via one or more second messages) as one or more delta configurations on top of one or more reference configurations. The one or more reference configurations may be managed separately, e.g., by the base station. The wireless device may store the one or more reference configurations as separate configuration(s), each.

In LTM, user plane may be continued whenever possible (e.g., intra-DU LTM, intra-DU mobility, intra-DU handover, and the like), without reset, with a target to avoid data loss and additional delay of data recovery. Security may not be updated in LTM. Subsequent LTM between candidate/target cell(s), of the one or more candidate/target cells, may be performed by the wireless device/base station without RRC reconfiguration. For example, the wireless device may not release candidate/target (LTM cell) configuration(s), of the one or more candidate/target (LTM cell) configurations, after LTM is triggered/completed.

LTM may support/comprise intra-gNB-distributed unit (DU) mobility (e.g., intra-DU mobility). LTM may support/comprise intra-gNB-central/centralized unit (CU) mobility (e.g., intra-CU mobility). LTM may support/comprise inter-gNB-DU mobility (e.g., inter-DU mobility). LTM may support/comprise inter-gNB-CU mobility (e.g., inter-CU mobility). LTM may support/comprise inter-frequency mobility, including mobility to inter-frequency cell that is not a current serving cell.

LTM may support/comprise PCell change in non-carrier aggregation (CA) scenario. For example, a source/serving cell may be a PCell. A candidate/target cell may not be a PCell. The wireless device may cell switch (e.g., cell switch via LTM, cell switch command MAC CE, LTM command MAC CE, and the like) to a candidate/target cell. After the cell switch, the candidate/target cell may be the PCell. The source/serving cell may not be the PCell after the cell switch.

LTM may support/comprise PCell change without SCell change in CA scenario.

LTM may support/comprise PCell change with SCell changes(s) in CA scenario. For example, a target candidate/target cell (e.g., target PCell/target SCell(s)) may not be a current serving cell (CA-to-CA scenario with PCell change). For example, the target PCell may be a current SCell. For example, the target SCell may be a current PCell.

The source/serving cell may be a PCell, SCell, PSCell, SpCell, and/or the like. Each candidate/target cell, of the one or more candidate/target cells, may be a PCell, SCell, activated SCell, deactivated SCell, PSCell, SpCell, non-serving cell, unlicensed cell, cell operating with shared spectrum channel access, FR1 cell, FR2 cell, and/or the like.

LTM may support/comprise dual connectivity (DC) scenario, at least for the PSCell change without master node (MN) involvement case, e.g., intra-secondary node (SN).

Cell switch trigger information for LTM may be conveyed (e.g., by/from the base station to the wireless device) in an L-1/2 command (e.g., MAC CE, activation command, cell switch command, cell switch MAC CE, cell switch command MAC CE, LTM command MAC CE, DCI, PDCCH order, and the like). The L-1/2 command may comprise at least a candidate/target (LTM cell) configuration index. The candidate/target (LTM cell) configuration index may indicate/identify a candidate/target cell (and/or a candidate/target (LTM cell) configuration) from/among/of the one or more candidate/target cells (and/or one or more candidate/target (LTM cell) configurations). Cell-specific, radio bearer, and/or measurement configurations may be part of a/each candidate/target (LTM cell) configuration of the one or more candidate/target (LTM cell) configurations.

The L-1/2 command may indicate TCI state(s) (or other beam information, e.g., reference signal, QCL assumption, spatial filter, spatial domain filter, spatial domain transmission filter, spatial domain reception filter, transmit beam, reception beam, and the like) to activate for the target/candidate cell(s).

SCell activation/deactivation (amongst SCells associated with the one or more candidate/target (cell) configurations) may be performed (e.g., by the wireless device and/or the base station) simultaneously with the L-1/2 command (e.g., may be referred to as LTM triggering MAC CE, cell-switch MAC CE, cell switch command, cell switch command/indication, LTM command MAC CE, control command, and the like).

The wireless device may perform contention based random access (CBRA) or contention free random access (CFRA) at/after cell switch (e.g., after receiving the control command, e.g., cell-switch MAC CE). The wireless device may skip random access (RA) procedure (e.g., the CBRA and/or the CFRA) if the wireless device does not need to acquire TA for the target/candidate cell during/after cell switch (e.g., in response to the wireless device determining TA of the target/candidate cell before/prior to receiving the control command). RACH resources for CFRA may be provided by the base station in one or more configuration parameters (or via the one or more candidate/target (LTM cell) configurations).

In an example, the L-1/2 command may indicate/provide CFRA resources. The wireless device may perform CFRA in/via the candidate/target cell using the CFRA resources.

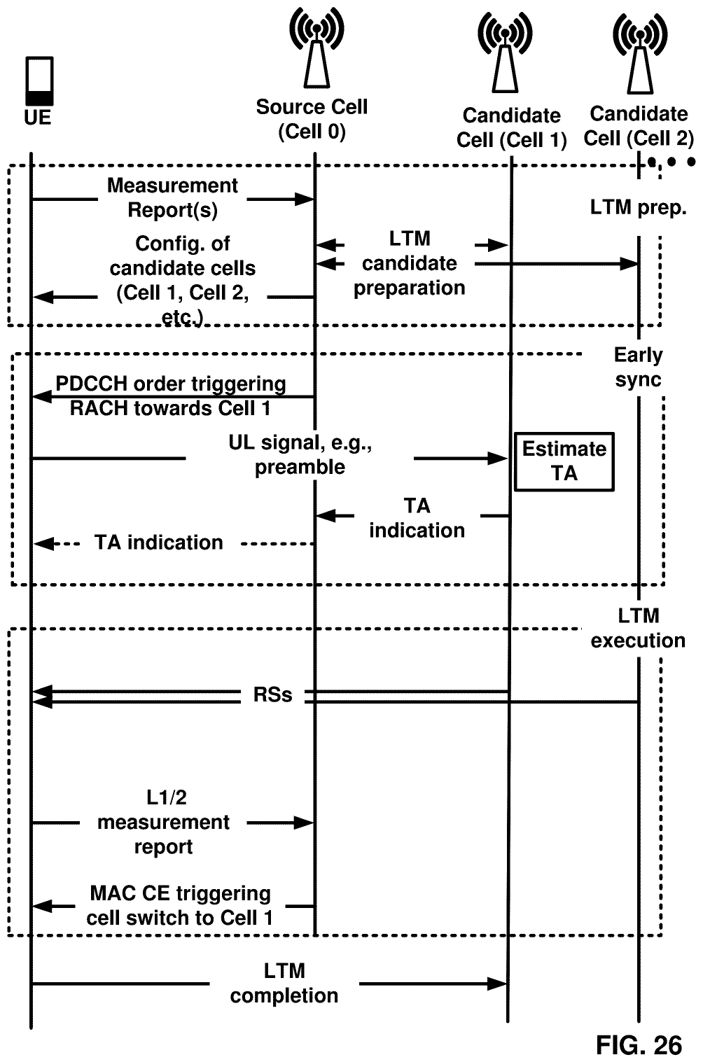

FIG. 26 shows procedure(s) for LTM as per an aspect of an embodiment of the present disclosure. Subsequent LTM may be done/performed (e.g., by the base station and/or the wireless device) by repeating early synchronization (early sync as shown in FIG. 26), LTM execution, and/or LTM completion steps/procedures (as shown in FIG. 26) without releasing other candidates (e.g., the one or more candidate/target (LTM cell) configurations) after each LTM completion.

In the example of FIG. 26, the wireless device (e.g., UE in FIG. 26 may transmit one or more measurement reports (e.g., Measurement Report(s) in FIG. 26). The one or more measurement reports may be, for example, one or more layer 3 (L3) measurement reports. The wireless device may transmit the one or more (L3) measurement reports to/via a base station/gNB (e.g., via Cell 0 in FIG. 26, a source/serving cell). The base station may determine to use/perform LTM, for example, based on the one or more (L3) measurement reports. The base station may initiate LTM candidate preparation (e.g., LTM prep. as shown in FIG. 26), for example, by coordinating with one or more candidate/target cells (e.g., one or more DUs, one or more source/serving DUs, one or more candidate/target DUs, and the like).

The base station may transmit one or more messages (e.g., RRC messages) to the wireless device. The one or more messages may comprise one or more candidate/target (LTM) cell configurations, e.g., for LTM/LTM procedure(s). The one or more messages may comprise one or more configuration parameters indicating/comprising the one or more candidate/target (LTM) cell configurations. The one or more candidate/target (LTM) cell configurations may be one or more RRCReconfiguration (parameters/messages). The wireless device may receive, from/via the base station (e.g., via a source/serving cell), a respective candidate/target (LTM cell) configuration, of the one or more candidate/target (LTM) cell configurations, for each candidate/target cell of the one or more candidate/target cells. The wireless device may store the one or more candidate/target (LTM cell) configurations of the one or more candidate/target cells. The wireless device may transmit RRCReconfigurationComplete message(s) to the base station (e.g., via the source/serving cell, Cell 0 in FIG. 26), for example, based on receiving and/or storing the one or more candidate/target (LTM cell) configurations.

The wireless device may perform early synchronization (e.g., Early sync as shown in FIG. 26). The early synchronization may comprise DL synchronization to/with/for/of candidate/target cell(s) of the one or more candidate/target cells (e.g., indicated in/by the one or more candidate/target (LTM cell) configurations). The wireless device may perform DL synchronization to/with/for/of candidate/target cell(s) before receiving the L-1/2 command (e.g., cell switch MAC CE, LTM command MAC CE), for example, based on/using one or more reference signals (e.g., based on measuring the one or more reference signals (e.g., SSB, CSI-RS, CRS, and the like), wherein each reference signal (RS) of the one or more RSs is associated/for/from/via a respective candidate/target cell of the one or more candidate/target cells).

The wireless device may perform timing advance (TA) acquisition (e.g., using an RA procedure as shown in FIG. 26 by transmitting an RA preamble, or without an RA procedure, e.g., based on wireless device/UE-based TA measurements, and the like). The early synchronization (e.g., early sync as shown in FIG. 26) may comprise the TA acquisition (e.g., may be referred to as early TA acquisition (ETA)). The TA acquisition may be referred to as, for example, uplink (UL) synchronization. The wireless device may perform TA acquisition (e.g., acquire TA(s) for/of/associated with candidate/target cell(s) of the one or more candidate/target cells). The wireless device may perform the TA acquisition, for example, before receiving the L-1/2 command (e.g., LTM (cell switch) command MAC CE, LTM command MAC CE, cell switch MAC CE).

The wireless device may acquire the TA(s) using an RA procedure (e.g., as shown in FIG. 26) based on receiving a control command (e.g., DCI, PDCCH order) (triggering RA channel (RACH) transmission, e.g., RA preamble transmission, RACH transmission, physical RACH (PRACH) transmission, RA preamble/PRACH transmission, and the like) towards/for/of/to/via candidate/target cell(s) of the one or more candidate/target cells. The wireless device may receive the control command (e.g., DCI, PDCCH order) from/via the source/serving cell.

The wireless device may perform L-1/2 measurements (e.g., of one or more RSs) on each/any candidate/target cell of the one or more candidate/target cells. The wireless device may transmit the L-1/2 (e.g., lower-layer, physical layer, MAC layer, and the like) measurement reports to the base station (e.g., via the source/serving cell). The wireless device may determine the L-1/2 measurement reports based on measuring one or more RSs from/associated with the one or more candidate/target cells, wherein at least one RS of the one or more RSs is from/associated with a respective candidate/target cell of the one or more candidate/target cells.

The base station/gNB may decide/determine to execute LTM cell switch to a target/candidate cell, of the one or more candidate/target cells, for example, based on (receiving) the L-1/2 measurements. The base station may transmit (e.g., via the source/serving cell) an L-1/2 command (e.g., LTM (cell switch) command MAC CE, LTM command MAC CE, cell switch MAC CE) triggering LTM cell switch (e.g., cell switch, cell switch for LTM, and the like). The L-1/2 command (e.g., LTM (cell switch) command MAC CE, LTM command MAC CE, cell switch MAC CE) may comprise a candidate/target (LTM cell) configuration index. The candidate/target (LTM cell) configuration index may indicate/identify a candidate/target (LTM cell) configuration, of the one or more candidate/target (LTM cell) configurations, of/for/associated with the target/candidate cell. The candidate/target (LTM cell) configuration index may indicate/identify a candidate/target cell of the one or more candidate/target cells. The wireless device may switch to/use the configuration of the (LTM) candidate/target cell indicated in the control command.

The wireless device may perform an RA procedure via/in the candidate/target cell (e.g., if a TA for/of the candidate/target cell is not available/valid at the wireless device).

The wireless device may indicate, for example, to/via the candidate/target cell/gNB/base station, of a successful completion of (LTM) cell switch towards the candidate/target cell. The wireless device may transmit one or more uplink (UL) messages to indicate LTM completion. LTM completion may comprise the successful completion of (LTM) cell switch towards the candidate/target cell.

Although the present disclosure may refer to an LTM (or LTM procedure), this procedure may alternatively be referred to as a cell switch procedure triggered by an L-1/2 command (e.g., LTM (cell switch) command MAC CE, LTM command MAC CE, cell switch MAC CE) (e.g., MAC CE, Layer 1/2 command/message, and the like) or as Layer 1/2 triggered mobility, MAC CE triggered cell switch procedure, non-handover, non-handover mobility, non-handover reconfiguration with sync, non-reconfiguration with sync mobility, and the like.

Early synchronization (e.g., Early sync as shown in FIG. 26 may comprise early TA acquisition (ETA). For ETA, the wireless device may perform an RA procedure. The RA procedure may be referred to as, for example, ETA procedure/process or ETA RA procedure. The RA procedure may be referred to as, for example, LTM TA acquisition. The RA procedure (e.g., for ETA, LTM TA acquisition, and the like) may be triggered/initiated, for example, by the base station. The RA procedure (e.g., for ETA, LTM TA acquisition, and the like) may be triggered/initiated, for example, by/via a (layer-1) control command (e.g., downlink control information (DCI), DCI format 1_0, physical downlink control channel (PDCCH) order, and the like). There may be (only) one RA procedure (e.g., the RA procedure) ongoing at any point in time in the wireless device (e.g., MAC entity of the wireless device).

The wireless device may transmit/perform, for the RA procedure, an RA preamble/PRACH transmission. Transmitting/performing the RA preamble/PRACH transmission may be referred to as, for example, PRACH transmission. The wireless device may transmit/perform the RA preamble/PRACH transmission over/on/via/using one or more PRACH/RA resources.

Based on (e.g., after, in response to, once) transmitting/performing the RA preamble/PRACH transmission, the wireless device may monitor (for) a PDCCH for RA response(s) identified by an RA-RNTI associated with the RA preamble/PRACH transmission while a ra-Response Window (e.g., RAR window, RAR timer, and the like) is running.

In an example, one or more messages (e.g., RRC message, MAC CE, DCI, PDCCH order, and the like) may indicate to the wireless device whether RAR is needed for PDCCH ordered RACH for a candidate/target cell in LTM.

For example, the one or more candidate/target (LTM cell) configurations (e.g., a/each candidate/target (LTM cell) configuration of the one or more candidate/target (LTM cell) configurations) may indicate whether RAR is needed (e.g., RAR monitoring is required, RAR is configured, and the like) for an RA procedure (e.g., RA preamble transmission, PRACH transmission, and the like) initiated/triggered by a (layer-1) control command toward/to/for/of/via a candidate/target cell of the one or more candidate/target cells. For example, a/each candidate/target (LTM cell) configuration of the one or more candidate/target (LTM cell) configurations may comprise a field indicating whether RAR is needed/required (e.g., noRAR within/in/comprised in LTM-EarlySyncConfig information element, which may be comprised in the candidate/target (LTM cell) configuration of the one or more candidate/target (LTM cell) configurations).

For example, a first candidate/target (LTM cell) configuration, of the one or more candidate/target (LTM cell) configurations, may be associated with a first candidate/target cell of the one or more candidate/target cells. A second candidate/target (LTM cell) configuration, of the one or more candidate/target (LTM cell) configurations, for example, may be associated with a second candidate/target cell of the one or more candidate/target cells.

A wireless device may receive a control command (e.g., DCI, PDCCH order, MAC CE, and the like). The control command (e.g., DCI, PDCCH order) may initiate/trigger/indicate an RA procedure. The control command may indicate an RA preamble/PRACH transmission, e.g., for the RA procedure.

In existing technologies, the control command may indicate a number of RA preamble/PRACH repetitions/transmissions for the RA procedure. For example, a base station may transmit the control command (e.g., DCI, PDCCH order). The base station may determine the number of RA preamble/PRACH repetitions/transmissions, for example, based on one or more measurement reports (e.g., Measurement Report(s) as shown in FIG. 26). The control command (e.g., DCI, PDCCH order) may indicate a mask index, for example, associated with the number of RA preamble/PRACH repetitions/transmissions. The mask index may indicate one or more ROs for the number of RA preamble/PRACH repetitions/transmissions.

The implementation of the existing technologies may result in an inaccurate determination of the number of RA preamble/PRACH repetitions/transmissions. For example, the wireless device may transmit (and/or the base station may receive) the one or more measurement reports at a first time. The base station may transmit (and/or the wireless device may receive) the control command (e.g., DCI, PDCCH order) at a second time. The control command (e.g., DCI, PDCCH order) may indicate the number of RA preamble/PRACH repetitions/transmissions. The wireless device may transmit/perform the number of RA preamble/PRACH repetitions/transmissions at a third time.

The base station may determine the number of RA preamble/PRACH repetitions/transmissions based on the one or more measurement reports that that base station received at the first time. Channel conditions (e.g., pathloss, scattering, doppler effects, attenuation, fading, and/or the like) may have changed between the first time and the third time. Determining a number of RA preamble/PRACH repetitions/transmissions to be transmitted/performed at the third time based on the one or more measurement reports received at the first time may result in the base station using outdated/inaccurate/old measurement reports to determine the number of RA preamble/PRACH repetitions/transmissions. Based on using outdated/inaccurate/old measurement reports to determine the number of RA preamble/PRACH repetitions/transmissions may result in the base station determining an inaccurate/wrong/incorrect number of RA preamble/PRACH repetitions/transmissions for the RA procedure.

Using an inaccurate number of RA preamble/PRACH repetitions/transmissions may lead to the wireless device using higher/more/greater/larger than a required number of RA preamble/PRACH repetitions/transmissions. Using a higher/more/greater/larger than the required number of RA preamble/PRACH repetitions/transmissions may result in increased latency, wastage and/or underutilization of network resources (e.g., RA resources), and/or reduction in battery life of the wireless device.

Using an inaccurate number of RA preamble/PRACH repetitions/transmissions may lead to the wireless device using less/lower/fewer than the required number of RA preamble/PRACH repetitions/transmissions. Using a less/lower/fewer than the required number of RA preamble/PRACH repetitions/transmissions may result in one or more failures of/in/for the number of RA preamble/PRACH repetitions/transmissions. The one or more failures may lead to one or more retransmissions of one or more RA preamble/PRACH repetitions/transmissions, which may cause increased signaling overhead, increase in latency, and/or reduction in battery life of the wireless device.

Embodiments of the present disclosure are related to an approach for determining a number of RA preamble/PRACH repetitions/transmissions for an RA procedure. These and other features of the present disclosure are described further below.

In an example embodiment, a wireless device receives a control command (e.g., DCI, PDCCH order). The control command (e.g., DCI, PDCCH order) may indicate a plurality of RA resources (e.g., a plurality of RA preambles, a plurality of ROs, a plurality of RO groups, and the like). Each RA resource, of the plurality of RA resources, may be associated with/for/correspond to a respective number of RA preamble/PRACH repetitions/transmissions of a plurality of numbers of RA preamble/PRACH repetitions/transmissions. The control command (e.g., DCI, PDCCH order) may indicate an RS (e.g., the control command (e.g., DCI, PDCCH order) may comprise an index of an RS) for the RA procedure. The wireless device may determine a number of RA preamble/PRACH repetitions/transmissions, of the plurality of numbers of RA preamble/PRACH repetitions/transmissions, for the RA procedure, for example, based on a radio link quality of the RS. The wireless device may transmit/perform the number of RA preamble/PRACH repetitions/transmissions via/using/with an RA resource, of the plurality of RA resources, that is for/associated with/corresponds to the number of RA preamble/PRACH repetitions/transmissions. In an example, the wireless device may receive the control command (e.g., DCI, PDCCH order) via a first cell (e.g., source cell, Cell 0 in FIG. 26). The wireless device may receive the RS via a second cell (e.g., candidate/target cell, Cell 1 in FIG. 26). The wireless device may transmit/perform the number of RA preamble/PRACH repetitions/transmissions via the second cell. In an example, the first cell may be different from (e.g., not the same as) the second cell. In another example, the second cell may be the same as the first cell.

Example embodiments of the present disclosure may provide enhancement for determining a number of RA preamble/PRACH repetitions/transmissions for an RA procedure. In response to the wireless device determining the number of RA preamble/PRACH repetitions/transmissions based on a radio link quality of an RS for (e.g., during/around the time of) the RA procedure, the wireless device may use an accurate (e.g., not outdated, not inaccurate, not old, correct, and the like) radio link quality (e.g., RSRP, channel quality, signal strength, and the like) to determine the number of RA preamble/PRACH repetitions/transmissions. Based on the base station giving the wireless device an opportunity to determine the number of RA preamble/PRACH repetitions/transmissions instead of the base station determining the number of RA preamble/PRACH repetitions/transmissions using/based on old/outdated/inaccurate measurement reports, the wireless device may use an accurate/correct/suitable number of RA preamble/PRACH repetitions/transmissions for the RA procedure. This may result in fewer RA preamble/PRACH repetitions/transmissions failure(s), fewer retransmissions of the RA preamble/PRACH repetitions/transmissions, reduced signaling overhead, reduced latency, and/or increased battery life of the wireless device.

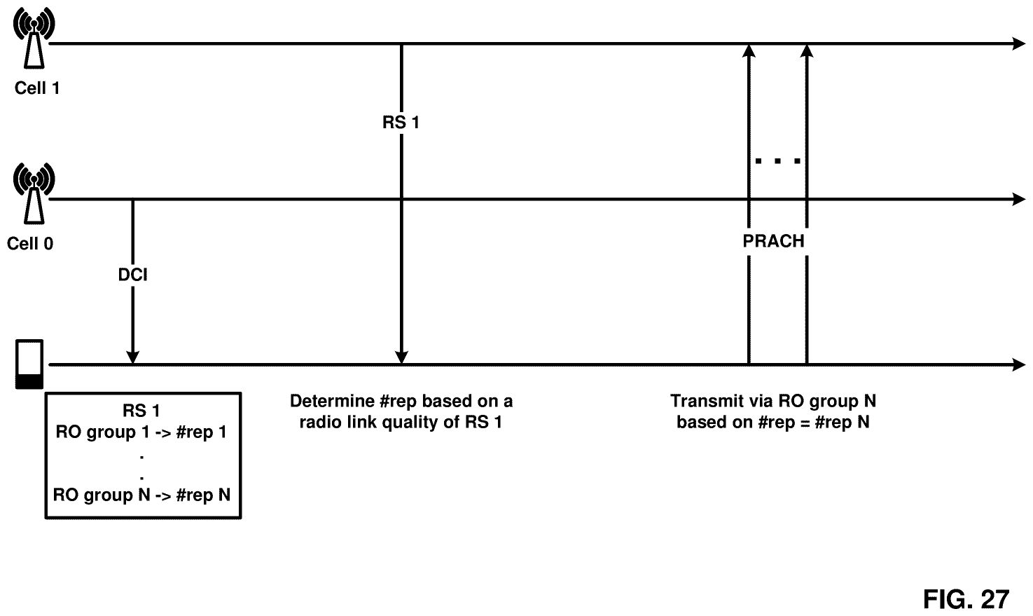

FIG. 27 illustrates an example timing diagram as per an aspect of an embodiment of the present disclosure. In the example of FIG. 27, a wireless device receives a control command (e.g., DCI, PDCCH order). The wireless device may receive the control command (e.g., DCI, PDCCH order) for a base station. For example, the base station may transmit the control command (e.g., DCI, PDCCH order) to the wireless device. The control command (e.g., DCI, PDCCH order) may indicate/initiate/trigger an RA procedure. In an example, the control command may be a DCI format 10 with CRC scrambled by C-RNTI. In an example, the control command (e.g., DCI, PDCCH order) may comprise a frequency domain resource assignment field. The frequency domain resource assignment field may be (set to) all ones.

In an example, the control command (e.g., DCI, PDCCH order) may comprise an uplink/supplementary uplink indicator. If the one or more configuration parameters comprises supplementaryUplink, the uplink/supplementary uplink indicator indicates which uplink carrier in the cell to transmit RA preamble/PRACH repetitions/transmissions.

In an example, the control command (e.g., DCI, PDCCH order) may indicate an RS. In the example of FIG. 27, the control command (e.g., DCI, PDCCH order) indicates RS 1. In an example, the control command (e.g., DCI, PDCCH order) may comprise an SS/PBCH index field. The SS/PBCH index field may indicate, for example, the RS (e.g., RS 1 in FIG. 27). The SS/PBCH index field may identify the RS (e.g., RS 1 in FIG. 27).

In an example, the control command (e.g., DCI, PDCCH order) may indicate an RA preamble. For example, the control command (e.g., DCI, PDCCH order) may comprise an RA preamble index field. The RA preamble index field may indicate/identify the RA preamble.

In an example, the control command (e.g., DCI, PDCCH order) may indicate a plurality of ROs/RO groups. In an example, each RO/RO group, of the plurality of ROs/RO groups, may be for/associated with/correspond to a respective number of RA preamble/PRACH repetitions/transmissions. For example, the control command (e.g., DCI, PDCCH order) may comprise one or more PRACH Mask index fields. The one or more PRACH Mask index fields indicate the plurality of ROs/RO groups.

In the example of FIG. 27, the control command (e.g., DCI, PDCCH order) may indicate the plurality of ROs/RO groups. The plurality of ROs/RO groups may comprise a first RO(s)/RO group (e.g., RO group 1 in FIG. 27). The first RO(s)/RO group may be for/associated with/correspond to a first number of RA preamble/PRACH repetitions/transmissions (e.g., #ep 1 in FIG. 27). The plurality of ROs/RO groups may comprise a second RO(s)/RO group (e.g., RO group N in FIG. 27). The second RO(s)/RO group may be for/associated with/correspond to a second number of RA preamble/PRACH repetitions/transmissions (e.g., #ep N in FIG. 27). In the example of FIG. 27, the plurality of ROs/RO groups may comprise N ROs/RO groups, where N=1, 2, 3, . . . 8, . . . , or the like.

In an example, the wireless device may receive the control command (e.g., DCI, PDCCH order) via/on/from a first cell. In an example of FIG. 27, the first cell is Cell 0. The first cell may be, for example, a serving cell. The first cell may be, for example, a PCell. The first cell may be, for example, an SCell. The first cell may be, for example, source cell. The first cell may be, for example, a non-terrestrial network cell.

The control command (e.g., DCI, PDCCH order) may indicate/initiate/trigger a number of RA preamble/PRACH repetitions/transmissions. In an example, the control command (e.g., DCI, PDCCH order) may indicate the number of RA preamble/PRACH repetitions/transmissions for/via a second cell. In the example of FIG. 27, the second cell is Cell 1. The second cell may be, for example, different from the first cell. The second cell may be, for example, the same as the first cell. The second cell may be, for example, a non-serving cell. The second cell may be, for example, a candidate/target cell (e.g., for LTM), of the one or more candidate/target cells.

In an example, a source base station (e.g., base station, a source DU, a source CU, and the like) may serve the first cell. In an example, a candidate/target base station (e.g., the base station, a candidate/target DU, a candidate/target CU) may serve the second cell.

The control command (e.g., DCI, PDCCH order) may indicate the RS (e.g., RS 1 in FIG. 27). The wireless device may receive the RS, for example, via the second cell.

The control command (e.g., DCI, PDCCH order) may indicate the number of RA preamble/PRACH repetitions/transmissions, for example, based on indicating the RS. The wireless device may measure the RS. The wireless device may determine a radio link quality (e.g., RSRP, RSRQ, SNR, BLER, signal strength, received power, and the like) of the RS (e.g., RS 1 in FIG. 27). The wireless device may receive the one or more configuration parameters, for example, via the first cell. The one or more configuration parameters may indicate one or more (power) thresholds. The one or more (power) thresholds may be (used) for determining the number of RA preamble/PRACH repetitions/transmissions. The one or more (power) thresholds may be, for example, one or more SSB-RSRP thresholds. The one or more (power) thresholds may be, for example, CSI-RS RSRP thresholds.

The wireless device may determine the number of RA preamble/PRACH repetitions/transmissions, for example, based on the one or more (power) thresholds. The wireless device may determine the number of RA preamble/PRACH repetitions/transmissions, for example, based on the radio link quality of the RS (e.g., RS 1 in FIG. 27). The wireless device may determine the number of RA preamble/PRACH repetitions/transmissions, for example, based on comparing the radio link quality of the RS (e.g., RS 1 in FIG. 27) to the one or more (power) thresholds.

In an example, the wireless device may determine the number of RA preamble/PRACH repetitions/transmissions to be the second number of RA preamble/PRACH repetitions/transmissions (e.g., #ep N in FIG. 27). In response to the number of RA preamble/PRACH repetitions/transmissions being the second number of RA preamble/PRACH repetitions/transmissions (or in response to determining the number of RA preamble/PRACH repetitions/transmissions to be the second number of RA preamble/PRACH repetitions/transmissions), the wireless device may determine the second RO(s)/RO group for the RA procedure, for example, based on the second RO(s)/RO group being associated with/for/corresponding to the second number of RA preamble/PRACH repetitions/transmissions (e.g., #ep N in FIG. 27).

The wireless device may transmit/perform the second number of RA preamble/PRACH repetitions/transmissions using/via/over the second RO(s)/RO group (e.g., RO group N in FIG. 27). The base station (e.g., candidate/target base station, base station serving the candidate/target cell, base station serving Cell 1, and the like) may receive the second number of RA preamble/PRACH repetitions/transmissions via/using/over the second RO(s)/RO group (e.g., RO group N in FIG. 27).

The wireless device transmit/perform the second number of RA preamble/PRACH repetitions/transmissions using/via/over the second RO(s)/RO group (e.g., RO group N in FIG. 27), for example, based on/after determining the number of RA preamble/PRACH repetitions/transmissions for the RA procedure. In an example, the second number of RA preamble/PRACH repetitions/transmissions may comprise the second number of transmissions/repetitions of the RA preamble (e.g., the RA preamble indicated by the control command (e.g., DCI, PDCCH order) and/or the RA preamble index/RA preamble index field).

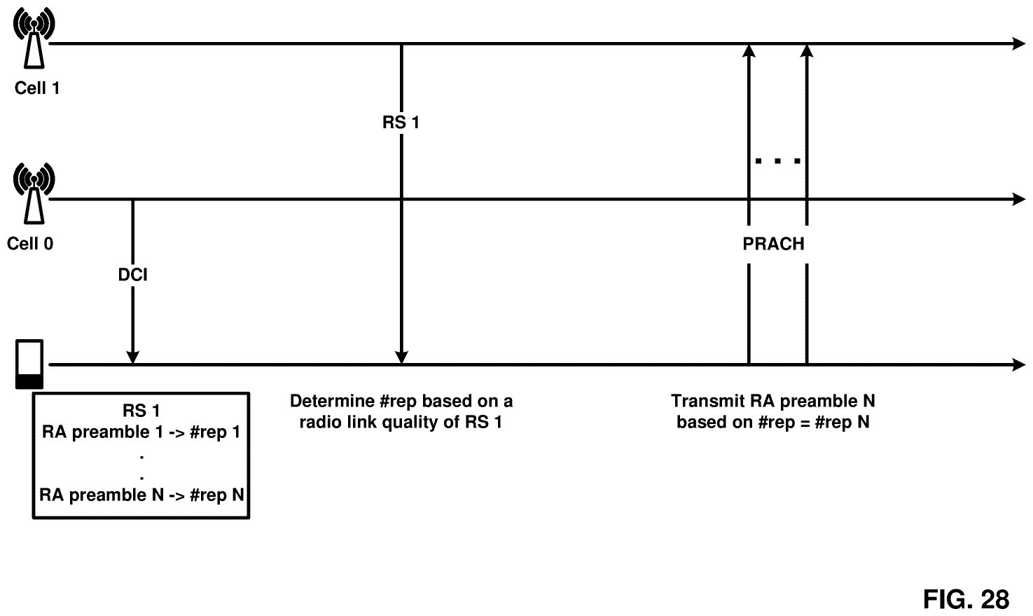

FIG. 28 illustrates an example timing diagram as per an aspect of an embodiment of the present disclosure. In the example of FIG. 28, the wireless device receives the control command (e.g., DCI, PDCCH order). The control command (e.g., DCI, PDCCH order) may indicate a plurality of RA preambles (e.g., a plurality of RA preamble indexes). For example, the control command (e.g., DCI, PDCCH order) may comprise the RA preamble index field. The RA preamble index field may indicate the plurality of RA preamble indexes and/or the plurality of RA preambles. In an example, the control command (e.g., DCI, PDCCH order) may comprise a plurality of RA preamble index fields. Each RA preamble index field, of the plurality of RA preamble index fields, may indicate/identify/correspond to/be associated with a respective RA preamble, of the plurality of RA preambles.

Each RA preamble, of the plurality of RA preambles, may be for/associated with/correspond to a respective number of RA preamble/PRACH repetitions/transmissions, of the plurality of numbers of RA preamble/PRACH repetitions/transmissions.

In the example of FIG. 28, a first RA preamble (e.g., RA preamble 1 in FIG. 28) may be for/correspond to/associated with a first number of RA preamble/PRACH repetitions/transmissions (e.g., #ep 1 in FIG. 28). A second RA preamble (e.g., RA preamble N in FIG. 28) may be for/correspond to/associated with a second number of RA preamble/PRACH repetitions/transmissions (e.g., #ep N in FIG. 28).

In the example of FIG. 28, the wireless device may determine the number of RA preamble/PRACH repetitions/transmissions to be the second number of RA preamble/PRACH repetitions/transmissions (for example, based on the radio link quality of the RS and the one or more (power) thresholds). The wireless device may transmit/perform the second number of RA preamble/PRACH repetitions/transmissions of the second RA preamble (e.g., RA preamble N in FIG. 28), for example, based on (determining) the number of RA preamble/PRACH repetitions/transmissions being the second number of RA preamble/PRACH repetitions/transmissions.

In an example, the control command (e.g., DCI, PDCCH order) may indicate/comprise a plurality of RA resources (e.g., a plurality of RA preambles, a plurality of ROs/RO groups), for example, in response to the wireless device transmitting wireless device capability message(s) indicating that the wireless device is capable of (e.g., can, supports, and the like) transmitting/performing a plurality of RA preamble/PRACH repetitions/transmissions.

In an example, the control command (e.g., DCI, PDCCH order) may indicate a plurality of ROs/RO groups based on comprising a first field (e.g., PRACH Mask Index field). The first field may indicate the plurality of ROs/RO groups, for example, based on indicating a starting RO of a respective RO group of the plurality of ROs/RO group.

In an example, the control command (e.g., DCI, PDCCH order) may indicate a plurality of ROs/RO groups based on comprising a plurality of fields (e.g., a plurality of PRACH Mask Index fields). The plurality of fields may indicate the plurality of ROs/RO groups, for example, based on each field, of the plurality of fields, indicating a starting RO of a respective RO(s)/RO group, of the plurality of ROs/RO groups.

In response to transmitting the second number of RA preamble/PRACH repetitions/transmissions via/on/over/to/toward the second cell (e.g., Cell 1 in FIG. 28, a candidate/target cell of the one or more candidate/target cells, and the like), the wireless device may receive an RA response (RAR). The wireless device may receive the RAR, for example, via/from/on/over the first cell (e.g., Cell 0 in FIG. 28, the source/serving cell, and the like). For example, the base station (e.g., serving base station, base station serving the source/serving cell, base station serving Cell 0, and the like) may transmit the RAR.

The RAR may correspond to the second number of RA preamble/PRACH repetitions/transmissions. In an example, the RAR may comprise/indicate an RA preamble index (e.g., RA preamble index of the second RA preamble). In an example, the RAR may be for/associated with/correspond to the second number of RA preamble/PRACH repetitions/transmissions. For example, the RAR may be for/associated with/correspond to each/any RA preamble/PRACH repetition/transmission, of the second number of RA preamble/PRACH repetitions/transmissions. In another example, the RAR may be for/associated with/correspond to all of the second number of RA preamble/PRACH repetitions/transmissions.

If CRC of a control command (e.g., DCI, PDCCH order, DCI format 1_0) is scrambled by C-RNTI and the “Frequency domain resource assignment” field are of all ones, the control command (e.g., DCI, PDCCH order, DCI format 1_0) may be for an RA procedure initiated by a PDCCH order. The control command (e.g., DCI, PDCCH order) may comprise a first field (e.g., an RA preamble index CE/repetition field). The first field may indicate one or more RA preamble indexes (e.g., one or more RA preambles) for the RA procedure with a plurality of RA preamble/PRACH repetitions/transmissions (e.g., where the wireless device uses a plurality of RA preamble/PRACH repetitions/transmissions for the RA procedure). The wireless device may transmit/perform the plurality of RA preamble/PRACH repetitions/transmissions (e.g., the plurality of RA preamble/PRACH repetitions/transmissions of the one or more RA preambles), for example, in response to/based on/after receiving the control command (e.g., DCI, PDCCH order).

If CRC of a control command (e.g., DCI, PDCCH order, DCI format 1_0) is scrambled by C-RNTI and the “Frequency domain resource assignment” field are of all ones, the control command (e.g., DCI, PDCCH order, DCI format 1_0) may be for an RA procedure initiated by a PDCCH order. The control command (e.g., DCI, PDCCH order) may comprise a first field. The first field may indicate one or more RA resources (e.g., one or more ROs/RO groups) associated with/for/corresponding to a number of RA preamble/PRACH repetitions/transmissions. Each/any of the one or more RA resources may be associated with/correspond to an RS indicated by the control command (e.g., DCI, PDCCH order). The device may transmit/perform the plurality of RA preamble/PRACH repetitions/transmissions via/over/on the one or more RA resources, for example, in response to/based on/after receiving the control command (e.g., DCI, PDCCH order).

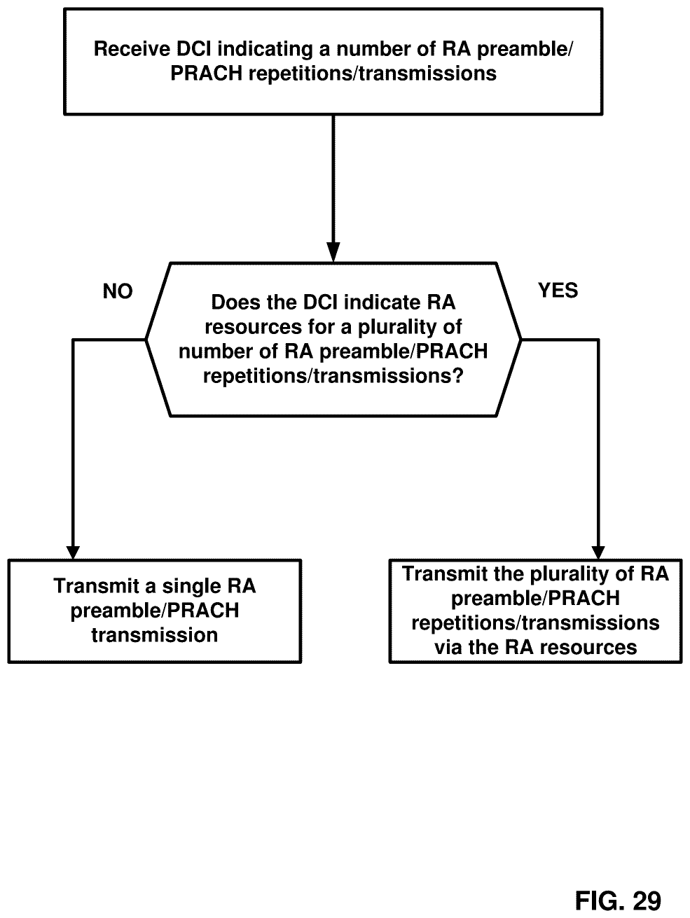

FIG. 29 illustrates an example flowchart as per an aspect of an embodiment of the present disclosure. In the example of FIG. 29, the wireless device receives a control command (e.g., DCI, PDCCH order). The control command (e.g., DCI, PDCCH order) may indicate a number of RA preamble/PRACH repetitions/transmissions. The number may be, for example, singular (e.g., 1). The number may be, for example, plural (e.g., 2, 4, 8, and/or the like).

In an example, the control command (e.g., DCI, PDCCH order) may indicate/comprise a plurality of RA resources (e.g., a plurality of RA preambles, a plurality of ROs/RO groups) for a plurality of RA preamble/PRACH repetitions/transmissions. For example, the control command (e.g., DCI, PDCCH order) may indicate/comprise the plurality of RA preambles for the plurality of RA preamble/PRACH repetitions/transmissions. In an example, the control command (e.g., DCI, PDCCH order) may indicate the plurality of ROs/RO groups for the plurality of RA preamble/PRACH repetitions/transmissions.

In response to the control command (e.g., DCI, PDCCH order) indicating/comprising the plurality of RA resources, the wireless device may transmit/perform the plurality of RA preamble/PRACH repetitions/transmissions over/via/using the plurality of RA resources. For example, the wireless device may transmit/perform the plurality of RA preamble/PRACH repetitions/transmissions of/using the plurality of RA preambles in response to the control command (e.g., DCI, PDCCH order) indicating/comprising the plurality of RA resources. For example, the wireless device may transmit the plurality of RA preamble/PRACH repetitions/transmissions via/on/using/over the plurality of ROs/RO groups in response to the control command (e.g., DCI, PDCCH order) indicating/comprising the plurality of RA resources.

In an example, the control command (e.g., DCI, PDCCH order) may not indicate/comprise the plurality of RA resources (e.g., a plurality of RA preambles, a plurality of ROs/RO groups) for the plurality of RA preamble/PRACH repetitions/transmissions. For example, the control command (e.g., DCI, PDCCH order) may comprise/indicate a single RA resource (e.g., a single RO, a single RA preamble, and the like) for a single RA preamble/PRACH transmission/repetition.

In response to the control command (e.g., DCI, PDCCH order) not comprising the plurality of RA resources for the plurality of RA preamble/PRACH repetitions/transmissions (and/or in response to the control command (e.g., DCI, PDCCH order) comprising/indicating the single RA resource for the single RA preamble/PRACH transmission/repetition), the wireless device may transmit/perform the single preamble/PRACH transmission/repetition, for example, of/using the single RA preamble via/using/over/on the single RO.

A method comprising: receiving, by a wireless device and via a first cell, one or more radio resource control (RRC) messages comprising configuration parameters of one or more candidate target cells for an LTM procedure; receiving, via the first cell, a downlink control information indicating: a plurality of ROs, wherein each RO, of the plurality of ROs, is associated with/for/corresponds to a respective number of RA preamble/PRACH repetitions/transmissions; and an RS for an RA procedure; determining a number of RA preamble/PRACH repetitions/transmissions based on a radio link quality of the RS; and transmitting via the second cell, of the one or more candidate target cells, the number of RA preamble/PRACH repetitions/transmissions via an RO, of the plurality of ROs, associated with the number of RA preamble/PRACH repetitions/transmissions.

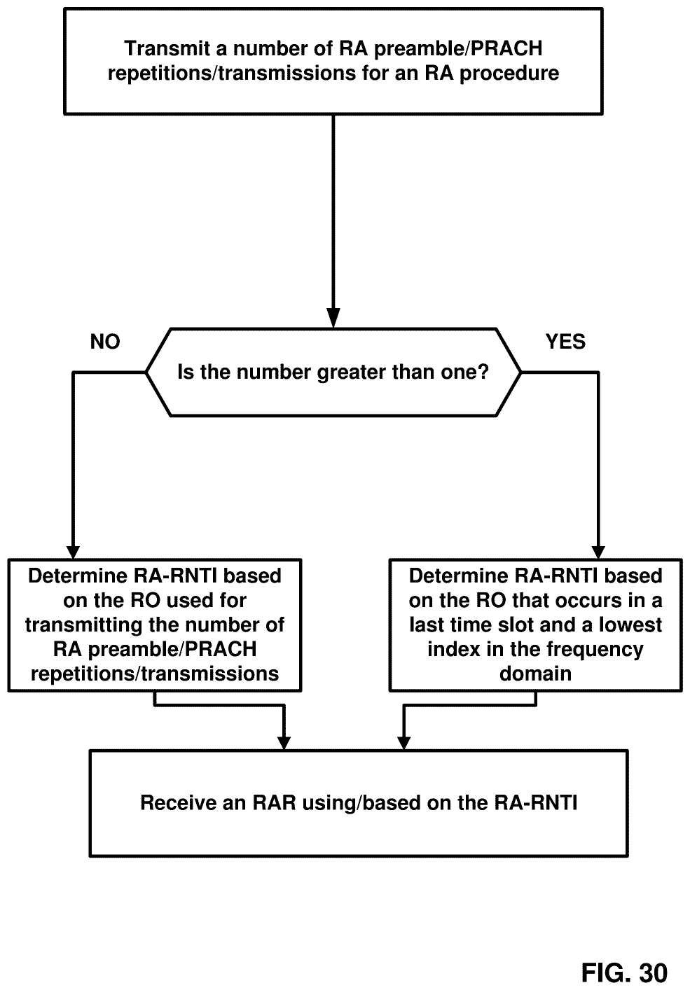

FIG. 30 illustrates an example flowchart as per an aspect of an embodiment of the present disclosure. In the example of FIG. 30, the wireless device transmits/performs a number of RA preamble/PRACH repetitions/transmissions. The wireless device may transmit/perform the number of RA preamble/PRACH repetitions/transmissions for an RA procedure (e.g., of/for a cell).

In an example, the number may be greater than one. The wireless device may transmit/perform a plurality of RA preamble/PRACH repetitions/transmissions, for example, based on the number being greater than one. The wireless device may transmit/perform the plurality of RA preamble/PRACH repetitions/transmissions, for example, via/using/on/over a plurality of ROs. The plurality of ROs may belong to/be comprised in a first RO group. The first RO group may be for/associated with/correspond to the number of RA preamble/PRACH repetitions/transmissions. In response to transmitting/performing the plurality of RA preamble/PRACH repetitions/transmissions, the wireless device may determine an RA-RNTI based on an RO of the plurality of ROs (e.g., as described in the example embodiment(s) of FIG. 21). The plurality of ROs may occur/be located in at least two time slots.

For example, the RO may be located/occur in a last time slot of the at least two time slots. The RO may be associated with a lowest index in the frequency domain among ROs, of the plurality of ROs, located in the last time slot of the at least two time slots.

In another example, the number may be one. The wireless device may transmit/perform a single RA preamble/PRACH transmission/repetition, for example, based on the number being one. The wireless device may determine an RA-RNTI based on the RO that the wireless device used/uses for transmitting/performing the single RA preamble/PRACH transmission/repetition.

In response to transmitting/performing the number of RA preamble/PRACH repetitions/transmissions, the wireless device may receive an RAR. The wireless device may receive the RAR using/with/based on the RA-RNTI.

A method comprising: receiving, by a wireless device, one or more configuration parameters indicating a plurality of random-access (RA) channel occasions (ROs) in at least two time slots; transmitting, via the plurality of ROs, a plurality of RA preamble repetitions; determining an RA-radio network temporary identifier (RNTI) based on an RO, of the plurality of ROs, that: occurs in a last time slot of the at least two time slots; and is associated with a lowest index in frequency domain in the last time slot; and receiving, based on the RA-RNTI, a random-access response corresponding to the plurality of RA preamble repetitions.

The above example method, wherein the one or more configuration parameters are: one or more radio resource control configuration parameters; and/or one or more system information parameters.

One or more of the above example methods, wherein the plurality of ROs comprise: one or more first ROs; and a second plurality of ROs.

One or more of the above example methods, wherein the one or more first ROs is different from the second plurality of ROs.

One or more of the above example methods, wherein each RO, of the one or more first ROs, is different from each/any RO, of the second plurality of ROs.

One or more of the above example methods, wherein the each RO, of the one or more first ROs, occurs/is located at a first time slot of the at least two time slots.

One or more of the above example methods, wherein each RO, of the second plurality of ROs, occurs/is located at the last time slot.

One or more of the above example methods, wherein the second plurality of ROs comprises the RO.

One or more of the above example methods, wherein the transmitting comprises transmitting each RA preamble repetition, of the plurality of RA preamble repetitions, via a respective RO of the plurality of ROs.

One or more of the above example methods, further comprising determining a second RA-RNTI based on a second RO, of the plurality of ROs, that: occurs in a last time slot of the at least two time slots; and is associated with a highest index in the frequency domain in the last time slot.

One or more of the above example methods, further comprising receiving, based on the second RA-RNTI, a second random-access response corresponding to the plurality of RA preamble repetitions.

A method comprises: transmitting, by a base station to a wireless device, one or more configuration parameters indicating a plurality of random-access (RA) channel occasions (ROs) in at least two time slots; receiving, via the plurality of ROs, a plurality of RA preamble repetitions; determining an RA-radio network temporary identifier (RNTI) based on an RO, of the plurality of ROs, that: occurs in a last time slot of the at least two time slots; and is associated with a lowest index in frequency domain in the last time slot; and transmitting, based on the RA-RNTI, a random-access response corresponding to the plurality of RA preamble repetitions.

In some embodiments, an RA procedure may be performed for a purpose (e.g., raPurpose). Based on the purpose of the RA procedure, a wireless device may determine (e.g., set, use, configure, and the like) a parameter (e.g., raPurpose) to a value corresponding to the purpose. In an example, the purpose may be initial access for the wireless device from RRC_IDLE/RRC_INACTIVE mode/state. In an example, the purpose may be RRC connection re-establishment. In an example, the purpose may be downlink or uplink data arrival during RRC_CONNECTED and/or RRC_INACTIVE when the uplink synchronization status is “non-synchronized.” In an example, the purpose may be uplink data arrival when there are no PUCCH resources for SR available to the wireless device. In an example, the purpose may be SR failure. In an example, the purpose may be request by a RRC layer of the wireless device upon synchronous reconfiguration (e.g., handover). In an example, the purpose may be RRC connection resume procedure from RRC_INACTIVE/RRC_IDLE state/mode. In an example, the purpose may be to establish time alignment for a secondary timing advance group. In an example, the purpose may be to request for other system information. In an example, the purpose may be for beam failure recovery. In an example, the purpose may be due to consistent uplink listen before talk (LBT) failure on a SpCell. In an example, the purpose may be for SDT in RRC_INACTIVE/RRC_IDLE mode/state. In an example, the purpose may be for positioning during RRC_CONNECTED state requiring the RA procedure, e.g., when timing advance is needed for positioning.

In an example, the RA procedure may be a 4-step (e.g., type-1) RA procedure. In an example, the RA procedure may be a 2-ste (e.g., type-2) RA procedure. In an example, the RA procedure may be a contention based RA (CBRA) procedure. The wireless device may select/transmit an RA preamble from a set of RA preambles dedicated to CBRA, for example, based on the RA procedure being a CBRA.

In an example, the RA procedure may be a contention free RA (CFRA) procedure. The wireless device may select/transmit an RA preamble from a set of preambles dedicated to CFRA, for example, based on the RA procedure being a CFRA.

In the present disclosure, a number of RA preamble/PRACH repetitions/transmissions refers to/implies/comprises one or more RA preamble/PRACH repetitions/transmissions. For example, the number of RA preamble/PRACH repetitions/transmissions may comprise a plurality of RA preamble/PRACH repetitions/transmissions. In an example, each RA preamble/PRACH repetition/transmission, of the plurality of RA preamble/PRACH repetitions/transmissions, may be the same RA preamble/PRACH transmission. In another example, one or more first RA preamble/PRACH repetitions/transmissions, of the plurality of plurality of RA preamble/PRACH repetitions/transmissions, may be different from one or more second RA preamble/PRACH repetitions/transmissions, of the plurality of different RA preamble/PRACH repetitions/transmissions. In an example, each RA preamble/PRACH repetition/transmission, of the plurality of RA preamble/PRACH repetitions/transmissions, may be different one another.

In an example, an nth RA preamble/PRACH repetition/transmission, of the number/plurality of RA preamble/PRACH repetitions/transmissions, x(n), may be generated by the wireless device according to x_{u,v}(n)=xᵤ((n+Cᵥ) mod L_{RA}),

$${x}_{u} ( i ) = {e}^{- j \frac{xui ( i + 1 )}{{L}_{RA}}} ,$$

i=0, 1, . . . , L_{RA}−1 from which the frequency-domain representation is generated according to

$${y}_{u , v} ( n ) = {\sum }_{m = 0}^{{L}_{RA} - 1} {x}_{u , v} ( m ) \cdot {e}^{- j \frac{2 π mn}{{L}_{RA}}}$$

where L_{RA}=839, L_{RA}=139, L_{RA}=1151, or L_{RA}=571 depending on the RA preamble/PRACH repetition/transmission format. There may be, for example, 64 RA preambles/PRACH repetitions/transmissions defined in each time-frequency PRACH occasion, enumerated in increasing order of first increasing cyclic shift Cv of a logical root sequence, and then in increasing order of the logical root sequence index, starting with the index obtained from the higher-layer parameter prach-RootSequenceIndex or rootSequenceIndex-BFR or by msgA-PRACH-RootSequenceIndex if configured and a type-2 random-access procedure is initiated. Additional preamble sequences, in case 64 preambles may not be generated from a single root Zadoff-Chu sequence, may be obtained from the root sequences with the consecutive logical indexes until all the 64 sequences are found. The logical root sequence order may be cyclic; the logical index 0 may be consecutive to L_{RA}−2. The sequence number u may be obtained from a logical root sequence index according to preconfigured table(s).

In an example, the wireless device may transmit a number of RA preamble/PRACH repetitions/transmissions. The number of RA preamble/PRACH repetitions/transmissions may be higher/greater/larger/more than one. Each RA preamble/PRACH repetition/transmission, of the number of RA preamble/PRACH repetitions/transmissions, may comprise a second number of repetitions of a sequence. In an example, the sequence may be a Zadoff-Chu sequence, logical root sequence, root sequence, and the like. The number of RA preamble/PRACH repetitions/transmissions may comprise transmitting the number of repetitions/transmissions of a second number of repetitions of the sequence. For example, the number of RA preamble/PRACH repetitions/transmissions may be two. The second number of repetitions may be four. Transmitting the number of RA preamble/PRACH repetitions/transmissions may comprise transmitting eight repetitions of the sequence. The number of RA preamble/PRACH repetitions/transmissions and the second number of repetitions of the sequence may, for example, be the same. The number of RA preamble/PRACH repetitions/transmissions and the second number of repetitions of the sequence may, for example, be different. In an example, the number of RA preamble/PRACH repetitions/transmissions may be one. The second number of repetitions of the sequence may be four. Transmitting the number of RA preamble/PRACH repetitions/transmissions (e.g., one, no repetitions, and the like) of the RA preamble may comprise transmitting the sequence four times, for example, based on the second number of repetitions being four.

What is claimed is:

1. A method comprising:
receiving, by a wireless device, one or more configuration parameters indicating a synchronization signal block (SSB);
determining, based on a received signal power of the SSB, a number of repetitions of a preamble for a random access procedure, the number of repetitions of the preamble comprising a first repetition and a second repetition;
determining a gap between a first symbol of the first repetition in a first slot and a second symbol of the second repetition in a second slot to be less than a first number of symbols; and
not transmitting the second repetition of the preamble based on determining the gap to be less than the first number of symbols.

2. The method of claim 1, wherein not transmitting the second repetition of the preamble is in the second slot.

3. The method of claim 1, wherein the preamble is for the random access procedure of a cell.

4. The method of claim 1, further comprising transmitting, in the first slot, the first repetition of the preamble.

5. The method of claim 1, wherein determining the number of repetitions is further based on a comparison of the received signal power with one or more power thresholds.

6. The method of claim 1, wherein each repetition, of the number of repetitions, of the preamble is associated with a same preamble index.

7. The method of claim 1, wherein the first symbol is located first in time among a plurality of symbols associated with the first repetition of the preamble.

8. A wireless device comprising:
one or more processors; and
memory storing instructions that, when executed by the one or more processors, cause the wireless device to:
receive one or more configuration parameters indicating a synchronization signal block (SSB);
determine, based on a received signal power of the SSB, a number of repetitions of a preamble for a random access procedure, the number of repetitions of the preamble comprising a first repetition and a second repetition;
determine a gap between a first symbol of the first repetition in a first slot and a second symbol of the second repetition in a second slot to be less than a first number of symbols; and
not transmit the second repetition of the preamble based on determining the gap to be less than the first number of symbols.

9. The wireless device of claim 8, wherein not transmitting the second repetition of the preamble is in the second slot.

10. The wireless device of claim 8, wherein the preamble is for the random access procedure of a cell.

11. The wireless device of claim 8, wherein determining the number of repetitions is further based on a comparison of the received signal power with one or more power thresholds.

12. The wireless device of claim 8, wherein each repetition, of the number of repetitions, of the preamble is associated with a same preamble index.

13. The wireless device of claim 8, wherein the gap is based on a sub-carrier spacing configuration.

14. The wireless device of claim 8, wherein the first number of symbols is based on a sub-carrier spacing (SCS) configuration.

15. A non-transitory computer-readable medium comprising instructions that, when executed by one or more processors of a wireless device, cause the wireless device to:
receive one or more configuration parameters indicating a synchronization signal block (SSB);
determine, based on a received signal power of the SSB, a number of repetitions of a preamble for a random access procedure, the number of repetitions of the preamble comprising a first repetition and a second repetition;
determine a gap between a first symbol of the first repetition in a first slot and a second symbol of the second repetition in a second slot to be less than a first number of symbols; and
not transmit the second repetition of the preamble based on determining the gap to be less than the first n umber of symbols.

16. The non-transitory computer-readable medium of claim 15, wherein the first symbol is located last in time among a plurality of symbols associated with the first repetition of the preamble.

17. The non-transitory computer-readable medium of claim 15, wherein the second symbol is located first in time among a plurality of symbols associated with the second repetition of the preamble.

18. The non-transitory computer-readable medium of claim 15, wherein the second symbol is located last in time among a plurality of symbols associated with the second repetition of the preamble.

19. The non-transitory computer-readable medium of claim 15, wherein the instructions further cause the wireless device to determine a set of physical random access channel (PRACH) occasions for transmitting the number of repetitions.

20. The non-transitory computer-readable medium of claim 15, wherein the gap and the first number of symbols are based on a sub-carrier spacing configuration.
